(19) United States
(12) Patent Application Publication
(10) Pub. No.: US 2019/0230969 A1
(43) Pub. Date: Aug. 1, 2019

(54) COMPOSITION OF PURIFIED SOLUBLE MANNANS FOR DIETARY SUPPLEMENTS AND METHODS OF USE THEREOF

(71) Applicant: Boston Therapeutics, Inc., Lawrence, MA (US)

(72) Inventors: Carl W. Rausch, Lawrence, MA (US); David Platt, Newton, MA (US)

(21) Appl. No.: 16/377,613

(22) Filed: Apr. 8, 2019

Related U.S. Application Data
(63) Continuation-in-part of application No. 13/938,409, filed on Jul. 10, 2013.
Application No. 13/938,409 is a continuation of application No. 13/882,040, now abandoned.
(60) Provisional application No. 61/410,609, filed on Nov. 5, 2010.

(51) Int. Cl. A23L 33/21; C08B 37/00

(52) U.S. Cl. CPC A23L 33/21; A23V 2002/00; C08B 37/0087; C08B 37/0003

(57) ABSTRACT

A composition of chemically purified soluble mannans from legumes' seeds (e.g. Ceratonia siliqua, Cæsalpinia spinosa Trigonelle foenum-graecum, and Cyamopsis tetragonolobus) and their use in the assembly of palatable dietary supplements is disclosed herein. The fractionation process provides high-quality physiologically soluble, chemically modified and purified homogeneous size polysaccharide fibers, devoid of natural impurities, for example proteins, alkaloids, glycoalkaloids, and/or environmental impurities including heavy metals, agricultural residues and microbial toxins. This process provides hypoallergenic dietary fibers devoid of any potential allergens, cytotoxins, and gastrointestinal toxins. A sequential process for assembly of the soluble fibers with plurality of molecular weights to create a time controlled dissolution of the functional high and low molecular weight fibers for improving solubility and palatability with improved dietary performance in the oral and gastro-intestinal system is also disclosed herein.

### CROSS REFERENCES TO RELATED APPLICATIONS

This application is a continuation-in-part of U.S. patent application Ser. No. 13/938,409, filed on Jul. 10, 2013, which is a continuation application of U.S. patent application Ser. No. 13/882,040, which is the National Stage Entry of International Patent Application No. PCT/US11/59271, filed on Nov. 4, 2011, which claims the benefit of U.S. Provisional Patent Application Ser. No. 61/410,609, filed on Nov. 5, 2010, the contents of which are incorporated herein by reference in their entirety.

### FIELD OF INVENTION

The present disclosure relates to the field of compositions of purified polysaccharides. More specifically, the present disclosure relates to extraction and purification of compositions for reducing the carbohydrate glycemic index of food and moderating blood glucose elevations.

### BACKGROUND of INVENTION

Diabetes mellitus, commonly known as diabetes, is a chronic metabolic disorder characterized by the body's inability to process glucose with insulin. Insulin, which is secreted by the pancreas, normally stimulates liver and muscle cells to take up glucose and store it as glycogen. However, in diabetic patients, they either do not produce enough insulin (type 1 diabetes) or produce insulin but are unable to process it due to an insulin resistance (type 2 diabetes). When glucose continuously rises to dangerous levels in the bloodstream inducing metabolic overload and elevated protein glycation, blood vessels are damaged and vital organs are directly affected (Jagdale et al., 2016). Diabetic complications include the triopathy (neuropathy, retinopathy, and nephropathy [Root et al., 1954]) as well as limb ischemia, and hepatic, cardiovascular, and cerebrovascular diseases. Diabetes currently affects more than 30.3 million people in the United States, which represents 9.4% of the population. There are also 84.1 million adults with prediabetes, including 23.1 million adults over the age of 64 years (CDC, 2017). Prediabetes is the state in which a person has higher than normal blood glucose level, but not great enough to be diagnosed with diabetes. People who have these levels of glucose are at increased risk of developing type 2 diabetes and subsequent cardiovascular and other organ complications (Bansal, 2015). Type 1 and type 2 diabetics generally manage their blood glucose levels on a meal-to-meal basis. Standard therapies for diabetes include physician-recommended exercise and diet, oral hypoglycemic drugs such as metformin for type 2 diabetics, and insulin injection regimens for type 1 diabetics. The objective of each is to maintain a blood glucose level range recommended by their physicians, typically with a fasting glucose level less than 100 mg/dL (5.6 mmol/L) (ADA, 2016).

Legumes' fiber has attracted considerable interest as a natural source of soluble dietary fiber. The legumes contain a central hard, yellow embryo surrounded by a corneous and comparatively large layer of white, semi-transparent endosperm. This endosperm contains a polysaccharide with a mannan backbone that contains mainly galactose side chains. The endosperm is surrounded by a tenacious, dark brown husk. The color of the gum fraction depends upon the amount of outer husk (brown color) and cotyledon (yellow color) present.

Unfortunately, commercially available flour of various legumes may have unwanted natural chemicals, flavors, and odors. Additionally they are of high viscosity and cannot be used for dietary supplements in a required clinically effective dosage. They also may contain a quantity of saponins of steroidal structures which may have toxic activities, including effecting fertility similar to steroid hormones effective as oral contraceptives. Saponins and alkaloids are known to cause a variety of toxicities when consumed in excess quantities. In order to produce a dietary supplement with a high effective load of soluble mannan polysaccharide fiber these saponins, other alkaloids and unwanted proteinous lipids, and other unpleasant components need to be removed to make a product suitable as a functional dietary supplement.

Nutrition research conducted in the 1970's showed that different carbohydrates did not have the same effects on blood glucose (sugar) levels after eating. These findings challenged the general assumption that all complex carbohydrates (starches) produce lower blood glucose responses than simple sugars, and questioned the clinical significance of carbohydrate exchange lists that have regulated the diets of people with diabetes for over three decades. These exchange lists are based on the assumption that portions of different foods containing equal amounts of carbohydrate will produce the same blood glucose response. Consequently, the glycemic index (GI) method was developed in order to rank equal carbohydrate portions of different foods according to the extent to which they increase blood glucose levels after being eaten. Foods with a high GI value (≥70) contain rapidly digested carbohydrate, which produces a large rapid rise and fall in the level of blood glucose. In contrast, foods with a low GI value (≤55) contain slowly digested carbohydrate, which produces a gradual, relatively low rise in the level of blood glucose.

Over two decades of research has confirmed that a food's effect on blood glucose levels can not be accurately predicted on the basis of the type and amount of carbohydrate it contains. This is because the rate at which carbohydrate is digested and released into the bloodstream is influenced by many food factors, such as the food's physical form, its fat, protein and fiber content, and the chemical structure of its carbohydrate. For these reasons, apparently similar foods within the same food group can produce widely different blood glucose responses. Therefore, it's necessary to measure the GI values of foods on an individual basis.

GI research has important implications for the food industry and people's health. Scientists now agree that the terms ‘complex carbohydrate’ and ‘sugars’, which commonly appear on food labels, have little nutritional or physiological significance. Recently, a committee of experts was brought together by the Food and Agriculture Organization of the United Nations (FAO) and the World Health Organization (WHO) to review the available research evidence regarding the importance of carbohydrates in human nutrition and health. The committee endorsed the use of the GI method for classifying carbohydrate-rich foods and recommended that GI values of foods be used in conjunction with information about food composition to guide food choices. Currently, GI values are being used to construct dietary plans for people with diabetes, and are being used in scientific research, which is examining the association between the glycemic impact of diets and the risk of certain diseases.

Over the last decade, a growing body of research has shown that the overall glycemic impact of people's diets can influence the development of insulin resistance and the risk of associated diseases (heart disease, diabetes), independently of the total carbohydrate content of the diet. To date, the available evidence suggests that diets based on low-GI carbohydrate-rich foods improve insulin sensitivity and blood glucose control in people with diabetes; reduce high blood fat levels; and may help prolong peak physical performance during endurance events. In addition, low-GI foods tend to be less refined and relatively filling and are therefore useful for weight control diets. Given that non-insulin-dependent diabetes (NIDDM) and coronary heart disease continue to be major causes of illness and death in all industrialized countries, the extent to which the glycemic impact of people's diets influences both the onset and progression of these diseases is an issue of great importance. Therefore, further research is required to determine the GI values of a greater range of carbohydrate-rich foods and to examine the effects of different processing methods. GI values of new foods and ingredients can be determined before they are released into the marketplace and their GI value can be stated on the food's nutrition panel to assist consumers in their efforts to lower the glycemic impact of their diet.

To date, few studies have measured postprandial blood glucose and insulin responses concurrently. This is due to the expensive cost of measuring insulin levels in blood samples and also reflects the widespread belief that glycemia is the only relevant postprandial factor to consider in the dietary therapy of people with diabetes mellitus. However, available research indicates that postprandial insulin responses to some foods are disproportionately greater than their blood glucose responses. A growing body of research results from dietary trials and large epidemiological studies indicates that the long-term consumption of a diet with a high glycemic load that induces recurring and high blood glucose and insulin levels is associated with an increased risk of developing insulin resistance, non-insulin-dependent diabetes mellitus, dyslipidemia, and cardiovascular disease. It may be possible to show a more direct link between diet and the risk of certain chronic diseases if a large database of the insulin index values of common foods was available.

Although dietary carbohydrate is a major stimulus for insulin secretion, other food factors such as certain amino and fatty acids also enhance insulin secretion. Foods rich in protein, but low in carbohydrate, such as meat or fish, induce relatively high levels of insulin secretion compared to their low blood glucose responses. In addition, foods rich in refined carbohydrate and fat, such as chocolate and certain bakery products, can produce insulin responses that are much greater than their postprandial glycemic responses. Recently, best-selling diet books in the USA have popularized the concept that carbohydrate-rich foods that trigger high insulin responses are particularly fattening. Unfortunately, the authors do not always correctly identify low- or high-insulinemic foods.

### SUMMARY of INVENTION

This disclosure is directed to compositions of purified mannan polysaccharides or mannan polysaccharide fibers from various legumes and methods of use thereof. The purified and homogenous size hypoallergenic fiber composed of over 50% mannose monosaccharide unit is useful in providing a single high dosage dietary supplement. This dietary supplement can be used to reduce the carbohydrate glycemic index of food and moderate blood glucose elevations by controlling sugar digestion and absorbance to the circulation.

In an illustrative embodiment, a composition of chemically purified soluble mannan polysaccharide fibers from legumes' seeds that include but are not limited to Ceratonia siliqua, Cæsalpinia spinosa Trigonelle foenum-graecum, and Cyamopsis tetragonolobus, and their use in the assembly of palatable dietary supplements is disclosed herein. A fractionation process provides high-quality physiologically soluble, chemically modified and purified homogeneous size mannan polysaccharide fibers, devoid of natural impurities, including proteins, alkaloids (soap-like foaming chemicals), glycoalkaloids (for example, sapogenins), environmental impurities such as heavy metals, agricultural residues, and microbial toxins.

In an illustrative embodiment, the purification process includes at least three phases of purification. The first phase of this process, according to the disclosure, starts with blending powdered legumes seeds to a semi-liquid mixture at conditions that solubilize and extract proteins and pigments from the semi-liquid mixture. The first phase may combine alkaline pH solution, baking soda, triphosphate, detergent, and/or mixtures thereof with the powdered legumes seeds. The alkaline processing can use any food grade or pharmaceutical grade alkaline solution including, but not limited to, sodium hydroxide (NaOH), potassium hydroxide (KOH), sodium bicarbonate (NaHCO₃), sodium carbonate (Na₂CO₃), and/or Triammonium base at about a 0.01 to about a 1 molar concentration. The ratio of alkaline to legumes' seed powder can range from about 1:2 to about 1:100 on a molar ratio basis.

In a second phase of the process, according to the disclosure, the semi-liquid mixture is diluted in acid and heated at a selected temperature for a selected period of time to solubilize minerals and to achieve partial hydrolysis of proteins and starch like polysaccharides. The acid diluents can be any food grade or pharmaceutical grade acids including, but not limited to, HCl, Citrate, Acetate, Sulfate, or mixtures thereof at concentrations of up to about 2 molars and a pH lower than about pH 4.0. Temperature and exposure time can range from about room temperature to boiling for periods of about 30 minutes to about 48 hours. The ratio of acid to the alkaline mixture may range from about 1:2 to about 1:20 on a molar ratio basis.

In a third phase of the process, according to the disclosure, the diluted semi-liquid mixture is mixed with a solvent for a period of contact time at a selected temperature in order to cause selected lipophilic compounds, including alkaloids; microbial endotoxins, for example lipopolysaccharides; mycotoxins, for example aflatoxins; as well as peptides, oligosaccharides and monosaccharides to solubilize and absorb into the solvent.

In an illustrative embodiment, the solvent concentration is adjusted to a selected concentration, where the legumes' seed mannan polysaccharide fibers are recovered as a precipitate out of the solvent phase. The sequential treatments produce a spent solvent that contains contaminant residues including fragmented proteins, solubilized starch like carbohydrates, pigments, alkaloids, and other seed lipophilic impurities components, while yielding a precipitate of purified mannan polysaccharide fibers.

The third phase of the process may include mixing the acidified mixture of legumes' seed with solvent in the range of about 1:2 to about 1:20 on a weight-to-weight basis (wt/wt). The solvent may be any food or pharmaceutical grade polar alcohol or ketone. In an illustrative embodiment, the solvent is about 95% ethanol (wt/wt) and the period of mixing time is in the range of about 30 to about 600 minutes. The temperature of the mixture during the contact time is in the range of about 5 to about 80 degrees Celsius. This step may be repeated by re-suspension in buffered solvent for improved recovery of fiber with high purity.

A fourth phase of the process, according to the disclosure, involves the separation of the extracted mannan polysaccharides or fibers from the solvent. In one illustrative embodiment, this is accomplished by centrifugation or filtration followed by vacuum drying. However, it should be appreciated that the separation can also be accomplished by other industrial process, for example rotary evaporation. In an illustrative embodiment, this phase may include washing with a polar alcohol at a concentration in the range of about 20% to about 95% ethanol (wt/wt). The final drying process may include agitation, vacuum, agglomeration and sieving. In this drying step, the mannan polysaccharide fiber is processed through vacuum, granulation and sieving to obtain powder ready for the manufacturing of dietary supplement in a pharmaceutical delivery packaging or medicament such as chewable tablet, caplets, gel-caps, succulents, and/or a concentrated liquid-gel format.

The overall industrial process could be conducted in sequential or continuous feeding modes. The process as described may include additives to improve extraction of impurities, for example, the addition of a food grade or pharmaceutical grade sulfiting agent to the solvent, for example, sulfur dioxide gas and one or more of salts of sulfite, bisulfite and metabisulfite, or hydrogen peroxide in the range of about 0.01% to about 0.4% (wt/wt).

In an illustrative embodiment, a composition, for example in the form of a tablet, is disclosed. The composition may comprise, consist, or consist essentially of at least one purified soluble mannan polysaccharide of high molecular weight. The composition may comprise, consist, or consist essentially of at least one purified soluble mannan polysaccharide of high molecular weight and at least one oligosaccharide or/and monosaccharide. The composition may comprise, consist, or consist essentially of at least one purified soluble mannan polysaccharide of low molecular weight. The composition may comprise, consist, or consist essentially of at least one purified soluble mannan polysaccharide of low molecular weight and at least one oligosaccharide or/and monosaccharide.

The composition may comprise, consist, or consist essentially of at least one purified soluble mannan polysaccharide of high molecular weight and at least one purified mannan polysaccharide of low molecular weight. The composition may comprise, consist, or consist essentially of at least one purified soluble mannan polysaccharide of high molecular weight, at least one purified mannan polysaccharide of low molecular weight, and at least one oligosaccharide or/and monosaccharide. The composition may comprise, consist, or consist essentially of 1 to 25% (wt/wt) of the at least one first purified soluble mannan polysaccharide of high molecular weight, 20 to 80% (wt/wt) of the at least one second purified mannan polysaccharide of low molecular weight, and 40 to 60% (wt/wt) of the at least one oligosaccharide and/or monosaccharide.

The composition may comprise, consist, or consist essentially of at least one purified soluble mannan polysaccharide of high molecular weight and at least one sugar alcohol. The composition may comprise, consist, or consist essentially of at least one purified soluble mannan polysaccharide of low molecular weight and at least one sugar alcohol. The composition may comprise, consist, or consist essentially of at least one purified soluble mannan polysaccharide of high molecular weight, at least one purified mannan polysaccharide of low molecular weight, and at least one sugar alcohol. The composition may comprise, consist, or consist essentially of at least one purified soluble mannan polysaccharide of high molecular weight, at least one purified mannan polysaccharide of low molecular weight, at least one sugar alcohol, and at least one oligosaccharide or/and monosaccharide. The sugar alcohol may include Sorbitol.

### BRIEF DESCRIPTION OF THE DRAWINGS

The compositions, systems, processes, and methods disclosed herein are illustrated in the figures of the accompanying drawings which are meant to be exemplary and not limiting, in which like references are intended to refer to like or corresponding parts, and in which:

FIG. 1 illustrates a block flow diagram of an embodiment of a method for recovering purified mannan polysaccharides;

FIG. 2 illustrates a chemical structure of a mannan polysaccharide;

FIG. 3 illustrates a block flow diagram of an embodiment of a method for recovering high molecular weight (HMW) purified mannan polysaccharides;

FIG. 4 illustrates a block flow diagram of an embodiment of a method for recovering low molecular weight (LMW) purified mannan polysaccharides;

FIG. 5 illustrates graphical comparison of a subjects blood glucose levels;

FIG. 6 illustrates a table of subject details;

FIG. 7 illustrates a table of the weight and macronutrient content of the test portions of the three rice test meals;

FIG. 8 illustrates a table of the order of presentation of the test meals;

FIGS. 9 and 10 illustrate tables of the subjects' individual blood glucose concentrations for RICE test meals;

FIGS. 11 and 12 illustrate tables of the subjects' individual blood glucose concentrations for RICE+3 mannan tablets test meals;

FIGS. 13 and 14 illustrate tables of the subjects' individual blood glucose concentrations for RICE+6 mannan tablets test meals;

FIG. 15 illustrates a table of plasma glucose concentrations for blood samples (mmol/L) collected during test sessions for the three test meals;

FIGS. 16 and 17 illustrate tables of the subjects' individual plasma insulin results for the RICE test meals;

FIGS. 18 and 19 illustrate tables of the subjects' individual plasma insulin results for the RICE+3 mannan tablets test meals;

FIGS. 20 and 21 illustrate tables of the subjects' individual plasma insulin results for the RICE+6 mannan tablets test meals;

FIG. 22 illustrates a table of plasma insulin results for blood samples (pmol/L) collected during test sessions for the three test meals;

FIG. 23 illustrates a table of heavy metal test results for a tablet containing about 2 grams of purified mannan polysaccharide(s);

FIG. 24 illustrates a graph of cytotoxicity test results of purified mannan polysaccharide(s);

FIG. 25 illustrates a table of microbial toxin test results of purified mannan polysaccharide(s);

FIG. 26 illustrates 1 D¹H NMR spectrum of SugarDown® sample, recorded in D20 at 40° C.;

FIG. 27 illustrates 1D ¹H NMR, zTOCSY 80 ms, NOESY 200 ms and gHSQCAD spectra of SugarDown® sample, recorded in D₂0 at 40° C.;

FIG. 28 illustrates MW distribution profiles by SEC analysis of intact SugarDown® tablets, Fenugreek Gum and Sunfiber® on Superose 12 column;

FIG. 29 illustrates MW distribution profiles by SEC analysis of intact SugarDown® tablets, Fenugreek Gum and Sunfiber® on Aquagel column;

FIGS. 30A-C illustrate MW distribution profiles by SEC analysis on Superose 12 column: intact SugarDown® (A), 100 KDa Retentate of the SugarDown® before (B) and after 2-hour ultrasonication (C);

FIG. 31 illustrates 1D-Proton NMR spectra of SD-d and F2 fraction isolated from the SD-u;

FIG. 32 illustrates 20-HSQC NMR spectra of SD-d and F2 fraction isolated from the SD-u;

FIGS. 33A-B illustrate Colorimetric Starch-iodine Assay;

FIG. 34 illustrates NMR-derived Apparent Rates of Amylase-Mediated Hydrolysis;

FIGS. 35A-B illustrate NMR Spectra of HSA (A) and PPA (B) in the Absence and Presence of GMα;

FIGS. 36A-B illustrate ¹H NMR Spectra of PPA in the Absence and Presence of GMβ (A) and Acarbose (B); and

FIG. 37 illustrates Schematic Representation on the Effect of SUGARDOWN® on Postprandial Glucose Level Compared to Baseline.

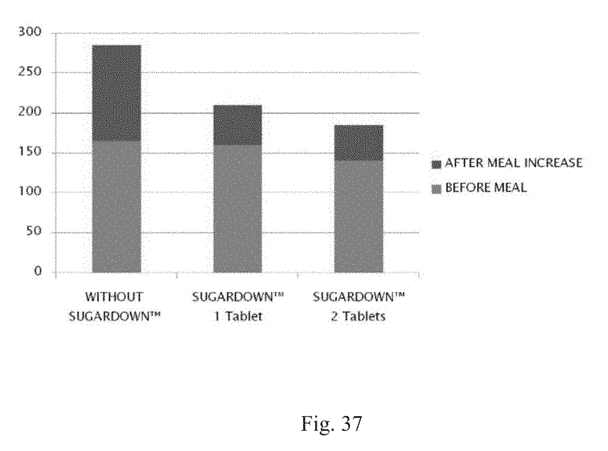

### DETAILED DESCRIPTION

Detailed embodiments of compositions, systems, processes, and methods are disclosed herein, however, it is to be understood that the disclosed embodiments are merely exemplary of the compositions, systems, processes, and methods disclosed herein, which may be embodied in various forms. Therefore, specific functional details disclosed herein are not to be interpreted as limiting, but merely as a basis for the claims and as a representative basis for teaching one skilled in the art to variously employ the present compositions, systems, processes, and methods disclosed herein.

In an illustrative embodiment, methods of extraction, purification and compositions of mannan polysaccharides dietary fibers (also referred to herein as “mannan polysaccharides” or “mannan polysaccharides fibers”) from legumes, such as but not limited to commercial or commercially grown legumes are disclosed herein. The purified and homogenous size hypoallergenic fiber(s) is useful in providing a single high dosage dietary supplement important to achieving overall health benefits. For example, a high mannan dosage is effective in supporting glycemic health, and maintaining normal blood sugar levels as well as lowering of cholesterol in blood. The high mannan dosage is a pro-biotic nutrient that supports the growth of beneficial bacteria and the maintenance of beneficial intestinal flora for colonic and intestinal health. The high mannan dosage also is effective in promoting a healthy digestive system and the absorption of essential nutrients.

In an illustrative embodiment, legume seeds are fractionated and the fractionated mannan polysaccharide(s) or fiber(s) is purified to generate a diversity of molecular weight polysaccharides. Various feasible processing methods and processes are disclosed to maximize yields and soluble fiber that can be incorporated into a soluble supplement composition that can deliver oral therapeutically effective doses of mannan polysaccharide fiber. The fractionation process may be conducted in either a sequential batch or continuous feeding mode.

In an illustrative embodiment, the extraction of pure soluble mannan polysaccharide fiber with a predetermined molecular weight is accomplished by treating the extracted legume seed material with acid at a constant pH and temperature for a period of selected contact time; and fractionating fibers in various concentrations of solvent, such as, but not limited to, ethanol. The solvent, for example ethanol, can be used in a concentration of between about 25% to about 65% on a weight-to-weight basis (wt/wt). However, it should be appreciated within the scope of the disclosure that other solvents may be used.

The solvent concentration is adjusted to a selected concentration, where the legumes' seed mannan polysaccharide fibers are recovered as a precipitate out of the solvent phase. Following precipitation, the fibers are placed in a solvent, washed, and dried. In an illustrative embodiment, collection of the precipitate is accomplished by centrifugation or filtration, and the washing of the fiber with an ethanolic acid mixture. Further, the washing step may be carried out a second or a number of additional times to improve the purity of the final product.

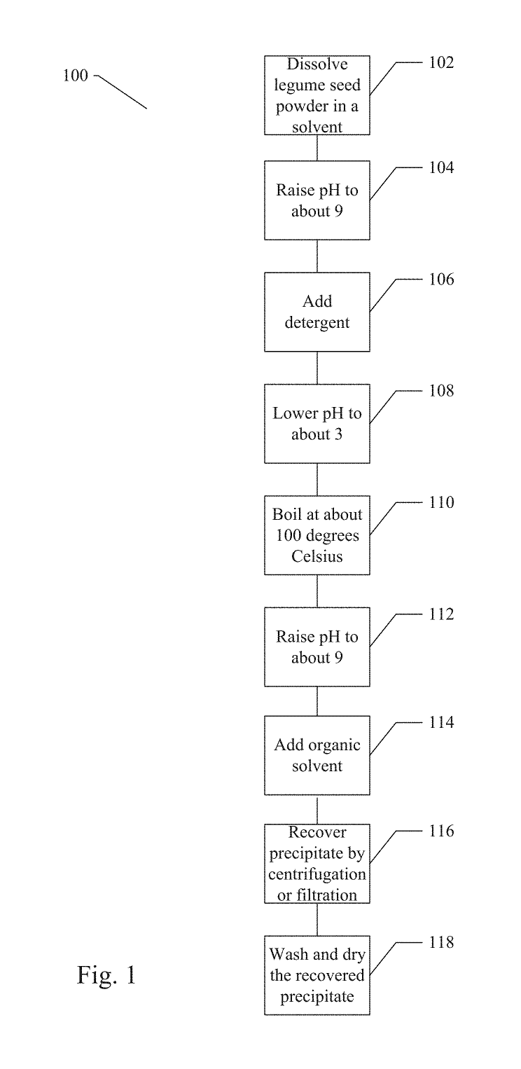

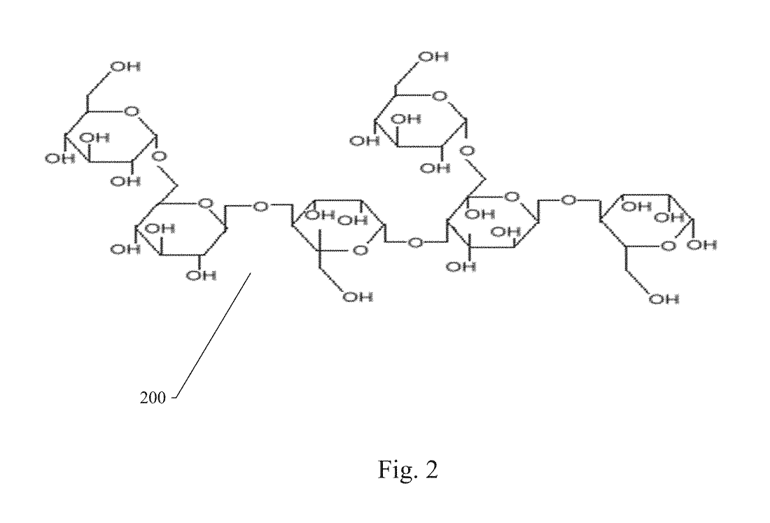

A process or method 100 for recovering one or more purified mannan polysaccharide fibers according to an illustrative embodiment is described with reference to FIG. 1. In this illustrative embodiment, the purified mannan polysaccharide fiber 200, illustrated in FIG. 2, is recovered or extracted from legume seed powder, such as but not limited to Cassia fistula, Ceratonia siliqua, Cæsalpinia spinosa Trigonelle foenum-graecum, and/or Cyamopsis tetragonolobus. The legume seed powder may be a commercially available powder of food grade or pharmaceutical grade. However, it should be appreciated that any pharmaceutically and/or nutritionally acceptable form of legume seed is suitable for use in the processes and methods disclosed herein. The extraction of the mannan polysaccharide fiber(s) may also be accomplished using raw seed by making powder or flakes from the raw seed, for example using common industrial methods and equipment.

In an illustrative embodiment, the process may be dived into phases. The first phase may include blending or dissolving the legumes seed powder in a first solvent to a semi-liquid mixture at conditions that solubilize and extract proteins and pigments from the semi-liquid mixture. This first phase may include combining alkaline pH solution, baking soda, triphosphate, detergent, and/or mixtures thereof with the legumes seed powder. The alkaline processing can use any pharmaceutically and/or nutritionally acceptable form of alkaline solution including, but not limited to, sodium hydroxide (NaOH), potassium hydroxide (KOH), sodium bicarbonate (NaHCO3), sodium carbonate (Na₂CO₃), Na₂CO₂, and/or Triammonium base at about 0.01 to 1 molar concentration. The ratio of alkaline to legumes' seed powder can range from about 1:2 to about 1:100 (wt/wt), inclusive of all ranges and sub-ranges in between. In an illustrative embodiment, the extraction process may require an agitator or a high power agitator due to the high viscosity of the semi-liquid mixture.

As illustrated in FIG. 1, the first phase includes dissolving the legume seed powder in a solvent, for example water, purified water, and/or distilled water, illustrated as 102. The ratio of the legume seed powder to the solvent may be in the range of about 1:10 to about 1:100 on a weight-to-volume basis (wt/v), inclusive of all ranges and sub-ranges in between. In this illustrative embodiment, the ratio of the legume seed powder to the solvent is about 1:15 (wt/v). The temperature for the extraction process may be in the range of about 25 to about 95 degrees Celsius, inclusive of all ranges and sub-ranges in between. In this illustrative embodiment, the initial temperature for the extraction is about 80 to about 95 degrees Celsius. However, through solubilization the temperature may drop to room temperature. The contact period may be in the range of about 2 to 24 hours, inclusive of all ranges and sub-ranges in between. In this illustrative embodiment, the contact period is about 4 hours.

At the end of the solubilization period the pH of the solvent is raised to about 9.0, for example, by adding sodium hydroxide and/or potassium hydroxide to the semi-liquid mixture, illustrated as 104. A mild natural detergent, including but not limited to sodium dodecyl sulfate may also be added to the semi-liquid mixture, illustrated as 106, to improve solubilization of proteins and lypophilic substances. This extraction step may last for a period of about 30 to about 60 minutes and be conducted at a temperature of about 37 degrees Celsius or less. It should be appreciated that various water alkaline and detergent mixtures, temperatures, contact times, and legume seed powder to solvent ratios may be used without departing from the scope and intent of this disclosure and that such substitution is contemplated within the scope of the present disclosure.

In a second phase of the process, the semi-liquid mixture may be diluted in acid and heated at a selected temperature for a selected period to solubilize minerals and to achieve at least partial hydrolysis of proteins and starch like polysaccharides. The acid diluents can be any pharmaceutically and/or nutritionally acceptable form of acid including, but not limited to, hydrochloric acid (HCl), Citrate, Acetate, and/or Sulfate at a concentration of up to about 2 molars and a pH lower than about 4.0. The ratio of acid to the alkaline semi-liquid mixture may range from about 1:2 to about 1:20 on a molar ratio basis, inclusive of all ranges and sub-ranges in between. The temperature and exposure time may range from about room temperature to boiling for periods of about 30 minutes to about 48 hours, inclusive of all ranges and sub-ranges in between. As illustrated in FIG. 1, the second phase includes acidifying the resulting semi-liquid mixture to a pH of about 3, illustrated as 108, and boiling the semi-liquid mixture at about 100 degrees Celsius for about 2 to about 5 hours, illustrated as 110.

After the semi-liquid mixture has been diluted and heated, the pH of the diluted mixture may optionally be adjusted back to a pH of about 9, illustrated as 112.

In a third phase of the process, the diluted mixture may be mixed with a solvent for a period of contact time at a selected temperature to solubilize and absorb certain lipophilic compounds, such as, but not limited to, alkaloids; microbial endotoxins, such as lipopolysaccharides; mycotoxins, such as aflatoxins; as well as peptides, oligosaccharides and monosaccharides into the solvent. In an illustrative embodiment, the third phase of the process includes mixing the acidified mixture of legumes' seed with solvent in the range of about 1:2 to about 1:20 (wt/wt), inclusive of all ranges and sub-ranges in between. The solvent may be any pharmaceutically and/or nutritionally acceptable form of solvent including, but not limited to, polar alcohols and/or ketones. In one illustrative embodiment the solvent is about 95% ethanol (wt/wt) and the period of mixing time is in the range of about 30 to about 600 minutes, inclusive of all ranges and sub-ranges in between. The temperature of the mixture during the contact time is in the range of about 5 to about 80 degrees Celsius, inclusive of all ranges and sub-ranges in between.

As illustrated in FIG. 1, the third phase includes adding an organic solvent, such as, but not limited to, ethanol to the mixture in about a 50% solvent concentration (wt/wt), illustrated as 114. In an illustrative embodiment, the solvent concentration is adjusted to a selected concentration, where the legumes' seed mannan polysaccharide fibers are recovered as a precipitate out of the solvent phase. This produces a spent solvent that contains contaminant residues including fragmented proteins, solubilized starch like carbohydrates, pigments, alkaloids, and other seed lipophilic impurity components, while yielding a precipitate of purified mannan polysaccharide fibers. In an illustrative embodiment, the third phase may be repeated one or more times, for example up to five times, by re-suspending the recovered fiber in buffered solvent for improved recovery of fiber with high purity.

In a fourth phase, the precipitated mannan polysaccharide fiber is extracted from the solvent by centrifugation or filtration followed by vacuum drying. However, it should be appreciated within the scope of the disclosure that extraction of the mannan polysaccharide fiber from the solvent can be accomplished by other industrial process, including rotary evaporation.

As illustrated in FIG. 1, the mannan polysaccharide fiber precipitates and is harvested or recovered by centrifugation or filtration, illustrated as 116. In this illustrative embodiment, the liquid filtrate contains protein, amino acids, oligo and monosaccharides, lipids, alkaloids, saponins, pigments, minerals and other impurities including breakdown organic derivatives. The solid fraction is about 90% (wt/wt) or greater pure mannan polysaccharide fiber, which at this point, may be re-extracted one or more times with a fresh quantity of solvent in order to maximize purity and recovery.

In an illustrative embodiment, the recovered mannan polysaccharide fiber may then be washed one or more times and dried, illustrated as 118. The recovered mannan polysaccharide fiber may be washed with a polar alcohol at a concentration in the range of about 20% to about 95% ethanol (wt/wt). The recovered mannan polysaccharide fiber may be dried by processing the recovered mannan polysaccharide fiber through vacuum, granulation, and sieving to obtain a powder. However, it should be appreciated that the recovered mannan polysaccharide fiber be dried by a number of different drying processes including, but not limited to, agglomeration, sieving, oven drying, agitation drying, fluid bed drying, freeze drying, and vacuum drying.

In this illustrative embodiment, vacuum drying is used. The dried mannan polysaccharide fibers contain about 90% (wt/wt) or greater of pure mannan polysaccharide fiber, which is white to off-white in appearance, odorless, tasteless and soluble in water. The purified mannan polysaccharide fiber powder may then be used for the manufacturing of dietary supplement in a pharmaceutical dosage form or medicament such as, but not limited to, a chewable tablet, caplets, gel-caps, succulents, and/or a concentrated liquid-gel format.

In an illustrative embodiment, the purified mannan polysaccharide fiber or polysaccharide powder is milled to about 50 to about 200 mesh powder and tested for water content. Based on the water content, further drying may be necessary for long stability and safe storage at room temperature.

While the extraction process described above is presented as a sequential batch process, it should be appreciated that a continuous mode such as a counter-current extraction mode of two or more stages, as is a common practice in the industry, may be used. The overall industrial process could be conducted in a sequential or a continuous feeding mode. The process may also incorporate additional additives to improve extraction of impurities, such as but not limited to the addition of a pharmaceutically and/or nutritionally acceptable sulfiting agent to the solvent, such as, but not limited to, sulfur dioxide gas and one or more salts of sulfite, bisulfite and metabisulfite, and/or hydrogen peroxide in the range of about 0.01% to about 0.4% (wt/wt).

In an illustrative embodiment, the final molecular weight of the mannan polysaccharide(s) may be controlled. The final molecular weight of mannan polysaccharide(s) is controlled at two steps, the time of boiling at pH of about 3 and fractionation of the final pure fiber in about 25%, about 45% and/or about 65% (wt/wt) ethanol in water. The lower concentrations of ethanol precipitate high molecular weight (HMW) fibers, for example about 60 kD to about 300 kD. The higher concentrations of ethanol precipitate low molecular weight (LMW) fibers, for example about 5 kD to about 40 kD. Further, the time of boiling or heating at high temperature is longer for producing LMW fibers. Conversely, the time of boiling or heating at high temperature is shorter for producing HMW fibers.

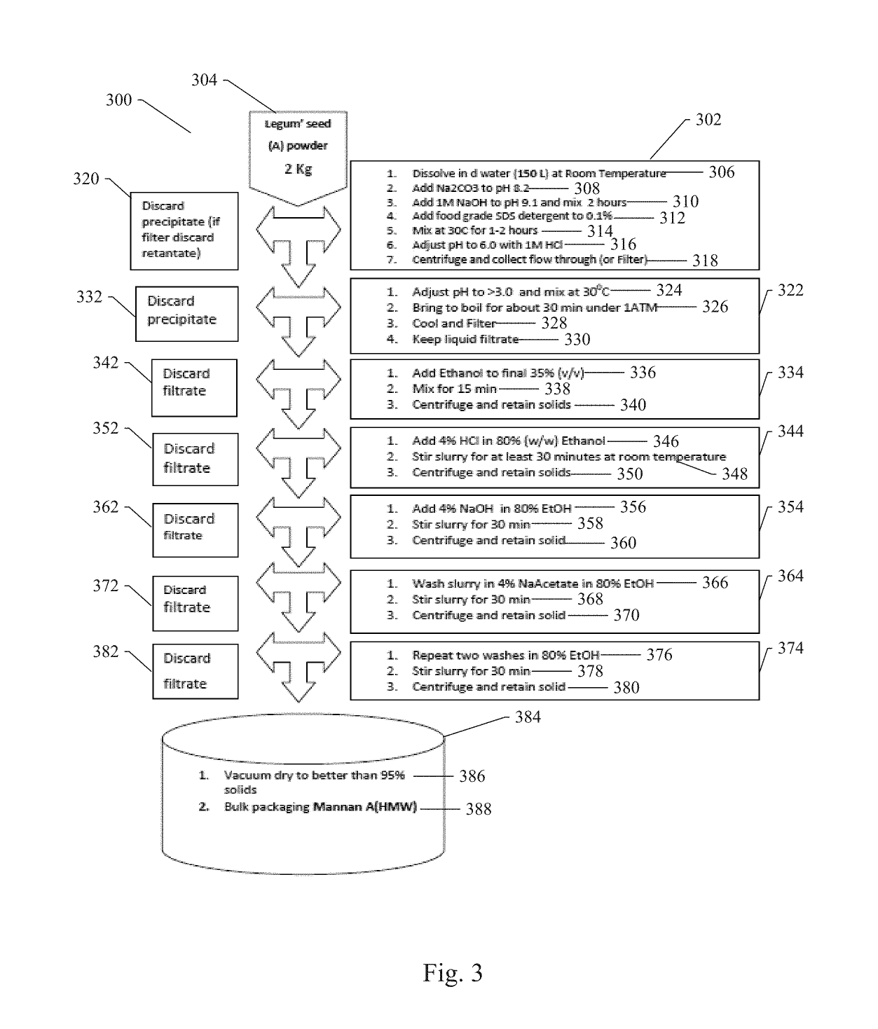

A process or method 300 for recovering one or more high molecular weight (HMW) purified mannan polysaccharide fibers according to an illustrative embodiment is disclosed with reference to FIG. 3. In this illustrative embodiment, the purified mannan polysaccharide fiber(s) is recovered or extracted from legume seed powder, for example Cassia fistula. As illustrated in FIG. 3, a first phase 302 of the process includes dissolving about 2 kilograms (kg) of legume seed powder 304 in about 150 liters of water at room temperature, illustrated as step 306. After the legume seed powder 304 is dissolved in the water, the pH of the mixture is raised to about 8.2 by adding a sufficient amount of sodium carbonate (Na₂CO₃), illustrated as step 308. The pH of the mixture may be raised further to about 9.1 by adding a sufficient amount of one molar sodium hydroxide (NaOH) and mixing the mixture for about 2 hours, illustrated as step 308.

A mild natural detergent, including, but not limited to, sodium dodecyl sulfate (SDS) may also be added to the mixture, illustrated as step 312, to improve the solubilization of proteins and lypophilic substances. The mixture may then be mixed at about 30 degrees Celsius for about 1 to about 2 hours, illustrated as step 314. After mixing the mixture, the pH may be lowered to about 6.0 by adding a sufficient amount of hydrochloric acid (HCl), illustrated as step 316. The mixture may then be processed through centrifugation and the liquid filtrate or flow through may be collected, illustrated as step 318. The precipitate collected can be discarded, illustrated as step 320.

In a second phase 322 of the process, the collected liquid filtrate is diluted in acid to a pH of about 3.0 and mixed at about 30 degrees Celsius, illustrated as step 324. The acidified mixture may then be heated and boiled for about 30 minutes at about 1 atm, illustrated as step 326, to solubilize minerals and to achieve at least partial hydrolysis of proteins and starch like polysaccharides. The acid diluents can be any pharmaceutically and/or nutritionally acceptable form of acid including, but not limited to, hydrochloric acid (HCl), Citrate, Acetate, and/or Sulfate at a concentration of up to about 2 molars and a pH lower than about 4.0. After heating, the acidified mixture may be cooled and filtered, illustrated as step 328. The liquid filtrate or flow through may be collected, illustrated as step 330. The precipitate collected can be discarded, illustrated as step 332.

In a third phase 334 of the process, ethanol may be added to the collected liquid filtrate in about a 35% on a volume-to-volume basis (v/v), illustrated as step 336. The resulting mixture may then be mixed for about 15 minutes, illustrated as step 338. After mixing, the mixture may be filtered or processed through centrifugation and the precipitate collected may be retained, illustrated as step 340. The liquid filtrate or flow through may be discarded, illustrated as step 342.

In a fourth phase 344 of the process, about 4% hydrochloric acid (HCl) in about 80% ethanol (wt/wt) may be added to the collected precipitate, illustrated as step 346. The resulting mixture may then be stirred for at least about 30 minutes at room temperature, illustrated as step 348. After stirring, the mixture may be filtered or processed through centrifugation and the precipitate collected may be retained, illustrated as step 350. The liquid filtrate or flow through may be discarded, illustrated as step 352.

In a fifth phase 354 of the process, about 4% sodium hydroxide (NaOH) in about 80% ethanol (wt/wt) may be added to the collected precipitate, illustrated as step 356. The resulting mixture may then be stirred for about 30 minutes, illustrated as step 358. After stirring, the mixture may be filtered or processed through centrifugation and the precipitate collected may be retained, illustrated as step 360. The liquid filtrate or flow through may be discarded, illustrated as step 362.

In a sixth phase 364 of the process, the collected precipitate may be washed with about 4% sodium acetate in about 80% ethanol (wt/wt), illustrated as step 366. The resulting mixture may then be stirred for about 30 minutes, illustrated as step 368. After stirring, the mixture may be filtered or processed through centrifugation and the precipitate collected may be retained, illustrated as step 370. The liquid filtrate or flow through may be discarded, illustrated as step 372.

In a seventh phase 374 of the process, the collected precipitate may be washed about two additional times in about 80% ethanol (wt/wt), illustrated as step 376. The resulting mixture may then be stirred for about 30 minutes, illustrated as step 378. After stirring, the mixture may be filtered or processed through centrifugation and the precipitate collected may be retained, illustrated as step 380. The liquid filtrate or flow through may be discarded, illustrated as step 382.

In an eighth phase 384 of the process, the collected precipitate may be dried by processing the collected precipitate through vacuum, granulation, and sieving to obtain a powder of better than about 95% solids (wt/wt), illustrated as step 386. The dried powder contains about 90% (wt/wt) or greater of pure HMW mannan polysaccharide fiber, which is white to off-white in appearance, odorless, tasteless and soluble in water. The purified HMW mannan polysaccharide fiber powder may then be packaged, illustrated as step 388, and used for the manufacturing of dietary supplement in a pharmaceutical dosage form or medicament such as, but not limited to, a chewable tablet, Caplets, Gel-caps, Succulents, and/or a concentrated liquid-gel format.

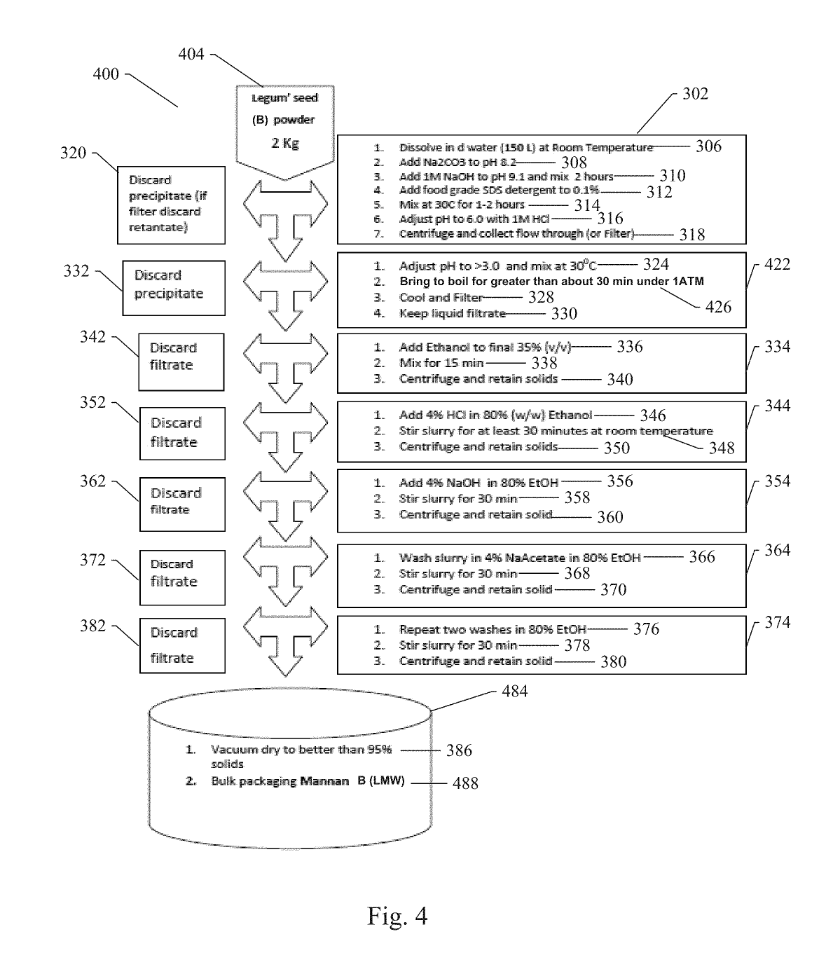

A process or method 400 for recovering one or more low molecular weight (LMW) purified mannan polysaccharide fibers according to an illustrative embodiment is disclosed with reference to FIG. 4. In this illustrative embodiment, the process 400 is similar to the process 300 described above with reference to FIG. 3. The differences between the process 400 and the process 300 are described below. According to the process 400, legume seed powder 404 is Trigonelle foenum-graecum. The process 400 includes a second phase 422, wherein the acidified mixture is heated and boiled for greater than about 30 minutes at about 1 atm, illustrated as step 426, to solubilize minerals and to achieve at least partial hydrolysis of proteins and starch like polysaccharides. The purified mannan polysaccharide fiber(s) recovered or extracted from the legume seed powder, in accordance with the process 400, is of a low molecular weight.

In this illustrative embodiment, the powder collected contains about 90% (wt/wt) or greater of pure LMW mannan polysaccharide fiber, which is white to off-white in appearance, odorless, tasteless and soluble in water. The process 400 also includes an eighth phase 484, wherein the purified LMW mannan polysaccharide fiber powder may be packaged, illustrated as step 488, and used for the manufacturing of dietary supplement in a pharmaceutical dosage form or medicament such as, but not limited to, a chewable tablet, Caplets, Gel-caps, Succulents, and/or a concentrated liquid-gel format.

While, the extraction processes described above are presented as a sequential batch process, it should be appreciated that a continuous mode such as a counter-current extraction mode of two or more stages, as is a common practice in the industry, may be used. It should also be appreciated that the use of various sources of legume seeds or flour as the raw material to be extracted may need adjustment in the temperature and/or time of contact to obtain the desired molecular weight. Additionally, in order to achieve allergenic free and toxin free mannan polysaccharide fiber further solvent washes may be required.

### Compositions

In an illustrative embodiment, the purified mannan polysaccharide(s) or fiber(s) is incorporated into a soluble supplement composition that can deliver oral therapeutically effective doses of mannan polysaccharide fiber. In an illustrative embodiment, the composition includes at least one purified soluble mannan polysaccharide of high molecular weight. In an illustrative embodiment, the high molecular weight mannan polysaccharide is about 50 to about 300 kD. In an illustrative embodiment, the composition includes at least one purified mannan polysaccharide of low molecular weight. In an illustrative embodiment, the low molecular weight mannan polysaccharide is about 5 to about 50 kD.

In an illustrative embodiment, the composition includes at least one purified soluble mannan polysaccharide of high molecular weight and at least one purified mannan polysaccharide of low molecular weight. In an illustrative embodiment, the composition includes at least one purified soluble mannan polysaccharide of high molecular weight, at least one purified mannan polysaccharide of low molecular weight, and at least one oligosaccharide, monosaccharide, and/or sugar alcohol.

The one or more oligosaccharides, monosaccharides, and/or sugar alcohols may include, but are not limited to, Mannitol, Erythritol, Sorbitol, Inositol, Raffinose (a nonreducing trisaccharide), Galactinol (dulcitol), Stachyose, Verbascose, Manninotriose, and higher homologs. In an illustrative embodiment, the composition includes about 1 gram of the at least one purified soluble mannan polysaccharide of high molecular weight, about 2 grams of the at least one purified mannan polysaccharide of low molecular weight, and about 1 gram of the sugar alcohol.

In an illustrative embodiment, the composition includes about 1% to about 50% (wt/wt) or about 1% to about 25% (wt/wt) of a purified soluble mannan polysaccharide of high molecular weight. In an illustrative embodiment, the composition includes about 20% to about 80% (wt/wt) of a purified soluble mannan polysaccharide of low molecular weight. In an illustrative embodiment, the composition includes about 40% to about 60% (wt/wt) of an oligosaccharides and/or monosaccharide. In an illustrative embodiment, the purified soluble mannan polysaccharide of high molecular weight has a high viscosity. In an illustrative embodiment, the purified soluble mannan polysaccharide of low molecular weight has a high solubility.

In an illustrative embodiment, the ratio of low molecular weight mannan to high molecular weight mannan may be about 2 to 1 (wt/wt), 20 to 1 (wt/wt), and up to about 100 to 1 (wt/wt), inclusive of all ranges and sub-ranges in between. In an illustrative embodiment, the compositions described above may optionally include one or more additional additives. In an illustrative embodiment, an additional additive may include one or more sugar alcohols, including, but not limited to, Sorbitol, Erithritol, Inositol, and other sugar alcohols of the type. A non-limiting list of other potential additional additives includes vitamins and minerals at their recommended % daily value requirements (for example, see www.USDA.gov).

In an illustrative embodiment, the compositions described above may optionally include or be combined with one or more diabetes medications or drugs, including, but not limited to, pioglitazone (for example Actos), glimepiride (for example Amaryl), rosiglitazone (for example Avandia), exenatide (for example Byetta), glyburide (for example DiaBeta), metformin (for example Glucophage), glyburide and metformin (for example Glucovance), glyburide (for example Glynase), miglitol (for example Glyset), insulin lispro (for example Humalog), Insulin Isophane, sitagliptin (for example Januvia), insulin glargine (for example Lantus), insulin aspart (for example NovoLog), saxagliptin (for example Onglyza), repaglinide (for example Prandin), acarbose (for example Precose), nateglinide (for example Starlix), liraglutide (for example Victoza), and other diabetes medications of the type.

In an illustrative embodiment, a composition in the form of a chewable tablet containing purified mannan polysaccharide fiber is produced. A Multi-Directional Motions mixer is used for to produce the chewable tablet. The Multi-Directional Motions mixer is run at about 5 to about 20 revolutions per minute (RPM). In an illustrative embodiment, the mixer has a mixing barrel supported by two crossing shafts, connected by Y-type universal joints, so that the mixing barrel combines turning, rocking and rolling motions to thoroughly and quickly mix the contents while avoiding gravity stratification of materials. The mixing barrel is a polished stainless-steel barrel type with no dead corners. The unique driven shaft servo mechanism ensures smooth and reliable operation with low vibration and noise. Mixing evenness exceeds 99.5%, and the charge coefficient achieves about 85%, better than traditional rotary mixers. The principal important components are the powerful drive system, digital control system, and good manufacturing practice (GMP) compliant mixing barrel.

In an illustrative embodiment, the temperature for the mixing is in the range of about 15 to about 35 degrees Celsius, which may be constant. In this illustrative embodiment, the temperature for the mixing is room temperature of about 23 degrees Celsius. The mixing period may be in the range of about 30 minutes to about 240 minutes. The contact period may be about 30 minutes.

In an illustrative embodiment, a sequential mixing protocol is disclosed where HMW mannan polysaccharide fibers are coated with or embedded in LMW mannan polysaccharide fibers by using a high performance V type multi-directional motion mixer or similar efficient agitator that mixes powder to evenness exceeding about 99.5%. The HMW individual mannan polysaccharide fiber is coated by molecular interaction with the LMW mannan polysaccharide fiber and the mixture or combined mannan polysaccharide fiber(s) is then embedded in one or more oligosaccharides and/or monosaccharides that also provide a sweet flavor. The composition when compacted into a chewable tablet is hard enough for automatic packaging and general handling, however, upon consumption and contact with water, saliva, or other fluid the tablet easily disintegrates and is dissolved in less than about 1 minute, to provide a palatable dietary supplement and reduce the glycemic index in foods, such as high carbohydrate foods. The tablet may also easily disintegrate and dissolve within about 1 minute to about 30 minutes.

In an illustrative embodiment, the compositions disclosed herein may be coated to provide for a time controlled dissolution of the functional high and/or low molecular weight mannan polysaccharide fibers for improving solubility and palatability with improved dietary performance in the oral and gastro-intestinal system opposed to the spiked profiles of immediate release formulations. In an illustrative embodiment, the compositions may be coated with one or more substances including, but not limited to, Hydroxy Propyl Methyl Cellulose (HPMC), Methyl Hydroxy Ethyl Cellulose (MHEC), Ethyl Cellulose (EC), Hydroxy Propyl Cellulose (HPC), Povidon, Sodium carboxy methyl cellulose, Polyethylene glycols (PEG), Acrylate polymers, Aqua-Zein®, which is an aqueous zein formulation containing no alcohol, Amylose starch and starch derivatives, and for enteric coating: Cellulose acetate phthalate (CAP), Acrylate polymers, Hydroxy propyl methyl cellulose phthalate, Polyvinyl acetate phthalate and other coatings known in the art.

In an illustrative embodiment, the compositions disclosed herein are useful in providing or producing a single high dosage dietary supplement and/or medicament important to achieving overall health benefits. For example, a high mannan dosage is effective in supporting glycemic health, and maintaining normal blood sugar levels as well as lowering of cholesterol in blood. The high mannan dosage is a pro-biotic nutrient that supports the growth of beneficial bacteria and the maintenance of beneficial intestinal flora for colonic and intestinal health. The high mannan dosage also is effective in promoting a healthy digestive system and the absorption of essential nutrients. The compositions disclosed herein are useful in veterinary and/or human medicine. The compositions may be administered orally to a patient or subject. The patient or subject may be a mammal, including non-human mammals. The compositions disclosed herein may be administered orally, as a chewable tablet, caplets, gel-caps, a pill, a dietary liquid-gel service unit, a succulent, and/or other types of administration of the type.

The active ingredient in SUGARDOWN® (BTI320 Chewable Tablets), which is designed to address the growing need for blood sugar management, is a proprietary fractionated mannan. Mannans are a group of plant-derived complex carbohydrates, or polysaccharides, that consist mainly of polymers of the sugar mannose (Yamabhai et al., 2016). Some of the plants from which mannans are derived are guar, locust bean, fenugreek, barley, and konjac. Published studies on mannans have shown that they possess significant biological activity ranging from inhibition of cholesterol absorption to promoting wound healing, inhibiting tumor growth, and hematologic benefits (Tizard et al., 1989; Srichamroen et al., 2008; Vázquez et al., 2017; Doshi et al., 2012). Studies have also shown that consuming mannans before a meal can lessen the rise in blood glucose after the meal (Vuksan et al., 1999; Williams et al., 2004). Therefore, supplementation with mannans may be beneficial in the management of diabetes by supporting healthy blood glucose levels.

The modified mannan in SUGARDOWN® (BTI320 Chewable Tablets), works to attenuate the rise in post-meal blood glucose (known as glucose excursion [ADA, 2001]) by (1) binding to long-chain starch polysaccharides in food and digestive enzymes that cleave these large sugars into glucose, directly and specifically inhibiting these enzymes at the molecular level, (2) temporarily coating the lumen of the small intestine to slow absorption of glucose, and (3) inducing satiety, thereby facilitating portion control as a secondary benefit. Together, these mechanisms of action lower glucose excursion systemically.

In a research effort to discover which foods are best in terms of blood sugar control for those with diabetes, the concept of the Glycemic Index (GI) was developed by Dr. David Jenkins and his team at the University of Toronto, Canada in 1981, coincidentally also where Nobel laureate Sir Dr. Frederick Banting and his medical student Charles Best discovered insulin in the pancreatic extracts of dogs 60 years earlier in 1921 (Bliss, 2014). GI is a measure of the ability of carbohydrates and other ingredients in food to raise plasma glucose levels after a meal. The three forms of carbohydrates in food include sugars, starches, and fiber. The GI is usually higher when the food contains more simple carbohydrates or glucose itself, which are quickly digested, absorbed systemically, and produce a rapid rise and fall in the level of blood glucose. Complex carbohydrates (i.e., foods with a low GI score) are digested more slowly causing a more gradual and relatively low rise in blood glucose level. A lower GI may also result in a lower insulin response, thereby improving long-term blood glucose control in both healthy and diabetic individuals.

Based on the body of scientific evidence for the mechanism of how mannans work (Gong et al., 2016; Trask et al., 2013; Trask et al., 2014), the formulation of mannans in SUGARDOWN® (BTI320 Chewable Tablets), has been optimized to slow down the post-meal digestion and absorption of glucose over time in order to moderate blood glucose levels. It is believed that SUGARDOWN® is a safe and effective dietary supplement for assisting prediabetics and diabetics in the management of their blood glucose levels. The dietary addition of SUGARDOWN®(BTI320 Chewable Tablets), may effectively reduce the total glycemic load in a high glycemic meal, thereby aiding in the control of blood glucose levels in people with diabetes, prediabetes, and other metabolic syndromes.

### PHYSICAL, CHEMICAL, AND PHARMACEUTICAL PROPERTIES AND FORMULATION

### Physical/Chemical Properties (B71320 Chewable Tablets) (Table 1),

Molecular Formula: Size at a broad range, polymer of [C₆H₁₀O₅]ₙ
Color/Form: Off-white, free-flowing powder.
pH: A 1% solution may reach a pH of 5.5-6.1 and tend to become more acidic while standing.
Solubilities: Completely soluble in water; practically insoluble in oils, greases, hydrocarbons, ketones, and esters.
Viscosity: A 1% solution may reach a viscosity of 2,700 cP (2,700 mPa·s).

TABLE 1
Chemical Ingredients

| Ingredient | Percentage by Weight (%) |
|---|---|
| Mannans | 40.0 |
| Malic Acid | 0.2 |
| Mountain Berry Flavor No. 3209183621.00 | 1.2 |
| Carmine 9350 50-53% | 0.02 |
| Sorbitol, Powdered Sorbogem ® 834 | 57.08 |
| Magnesium Stearate Vegetable (AIC) | 1.0 |
| TOTAL | ~100 |

### Other Physical/Chemical Properties

The mannose-galactose ratio is broad and the molecular weight ranges approximately 250 to 2,500 g/mol. The maximum viscosity is reached in approximately 2 hr in cold water and the rate of hydration and viscosity are increased at higher temperatures. Solutions are slightly cloudy due to the presence of a small amount of insoluble fiber and cellulose. Further, solutions are thixotropic and viscosity is relatively unaffected by the presence of electrolytes. Solutions are compatible with starch, gelatin, and other water-soluble gums. Mannans are composed of a straight chain of D-mannose with a D-galactose side chain (Furia, 1972). Sugar units: D-mannose beta-(1->4), D-galactose-(1->6) branches (Merck Index, 1976). (See Table 2)

TABLE 2
Product Master Composition

| | | | Amount |
|---|---|---|---|
| Ingredients | Chemical Name | Appearance | per Tablet |
| Mannan | [1-6 alpha-D-Xn-{(1-4)- | White to | 40% |
| Polysaccharides | beta-D-mannose}]ₐ | cream powder | |
| (SFR and | | | |
| M800) | | | |
| Sorbitol | C₆H₁₄O₆ | White powder | 57.08% |
| Malic Acid | HO₂CCH₂CHOHCO₂H | White powder | 0.20% |
| Magnesium | Mg(C₁₈H₃₅O₂)₂ | White powder | 1% |
| Stearate | | | |
| Natural Food | NA | Pink Powder | 0.02% |
| Colors: Carmine | | | |
| Flavor | N/A (Frutarom, NJ, | White Powder | 1.2% |
| | USA) | | |

The dietary ingredient of interest is plant dietary fiber in the form of naturally hydrolyzed and purified fibers, which is composed of complex carbohydrate polymers with a linear backbone structure of poly-(beta-D-mannose), also identified as mannan polysaccharides.

### Nonclinical Pharmacology

The hypoglycemic effect of Trigonella foenum-graecum Linn (common name fenugreek) is well documented (Eidi et al., 2007; Shani et al., 1974; Yadav et al., 2004). An assessment report on the effects of on semen, by the European Medicines Agency, had only one study dealing with the effect of fenugreek seeds on appetite. Petit and colleagues (1993) found that oral administration of a hydro-ethanolic seed extract increased food intake and motivation to eat in rats. Interestingly, an increase in plasma insulin and a corresponding decrease in total cholesterol and VLDL and LDL were observed. Muraki and colleagues (2011) studied rats fed diets supplemented with increasing percentages of fenugreek powder (12% of which is galactomannan). Reductions in plasma insulin and glucose levels and body weight were observed only at the highest dose (12.3% fenugreek in a high-fat high sucrose diet [50% lard, 25% sucrose]). The results suggest that fenugreek inhibited lipid accumulation in the liver by increasing the lipid excretion in the feces. No change in liver enzymes was observed in any group. The effective, safe, and tolerable dose of fenugreek was found to be around 2.50% (w/w) (0.3% galactomannan).

Hypocholesterolemic effects have also been reported in studies conducted on normal and diabetic dogs (Ribes et al., 1984; Ribes et al., 1986; Ribes et al., 1987; Valette et al., 1984) and in humans with guar gum (review by Butt et al., 2007). Partially hydrolyzed guar gum (PHGG; also known as modified guar gum), which is different from guar gum in that its viscosity at high concentrations is markedly lower, has also been studied in animals. Lamp and colleagues (1992) showed suppression of plasma cholesterol by PHGG in rats fed chow containing 5% PHGG for 21 days. PHGG performed similarly to unmodified guar gum.

Fenugreek has pronounced anti-inflammatory effects as measured in the formalin-induced rat paw edema model (Ahmadiani et al., 2001) as well as a protective effect on lipid peroxidation and enzymatic antioxidants in rats exposed to cyclophosphamide and L-buthionine-SR-sulfoximine—known urotoxins (Bhatia et al., 2006). Further, fenugreek decreased blood glucose, blood lipid levels, and improved hemorheological parameters in streptozotocin diabetic rats after treatment for six weeks compared with the untreated control group (Yue et al., 2007). Others have described immunomodulatory and analgesic effects of fenugreek in animal and humans (Bin-Hafeez et al., 2003; Goyal et al., 2016; Abdel-Daim et al., 2015; Parvizpur et al., 2004; Younesy et al., 2014).

### Toxicology

Fenugreek seeds and its powder, dry or soft extract, are generally considered as safe and non-toxic. In a 90-day toxicology study (Rao et al., 1996), rats consumed diets supplemented with 5, 10, and 20% fenugreek seeds (equivalent to 2.4 g galactomannan if seeds comprise ˜12% galactomannan). No differences were found between the control group and the three dose groups with respect to body weight, food intake, and feed efficacy ratio (ratio of weight gain to food intake). Likewise, there were no statistically significant differences with respect to hematological parameters (hemoglobin [Hgb], packed-cell volume [PCV], and white blood cells [WBC]) and liver enzymes. Serum cholesterol was reduced in the higher two doses. It was concluded that fenugreek seeds were non-toxic at these doses. Normal and castrated rats were fed 10 or 35 mg/kg oral galactomannan (equivalent to 1.61 or 5.64 mg/kg [113 or 395 mg in a 70 kg person, respectively]) or testosterone (10 mg/kg subcutaneously biweekly) for 4 weeks to assess male reproductive hormones and organs (Aswar et al., 2007). Compared with testosterone, galactomannan (35 mg/kg orally) had no effect on BUN and testosterone levels compared with increases with testosterone treatment. The investigators noted an increase in weight of the levator ani muscle and body weight in those rats treated with galactomannan 35 mg/kg and in castrated rats treated with testosterone 10 mg/kg. In non-castrated rats, both galactomannan and testosterone did not alter the normal architecture of the testis. Galactomannan (35 mg/kg orally) is an anabolic compound without androgenic activity compared to anabolic and androgenic testosterone. These studies suggest that at doses equivalent to those intended for use with SUGARDOWN® (BTI320 Chewable Tablets), (corrected for species), both crude seed flour from fenugreek as well as isolated galactomannan (that ordinarily ranges at 12-17% of total seed mass) are safe and well-tolerated.

The uterine stimulant properties reported on the guinea pig uterus should be viewed in the context of its historical use as an abortifacient or for labor induction (Abdo and Kafawi, 1969; Farnsworth et al., 1975; Ulbricht et al., 2007). Yadav and Baquer (2013) reviewed all previous literature, including those data dating back to the 1970′s, and concluded that Trigonella foenum-graecum L. is a carminative, gastric stimulant, antidiabetic, and galactogogue, as well as having anticholesterolemic, antilipidemic, antioxidant, hepatoprotective, anti-inflammatory, antibacterial, antifungal, antiulcer, antilithigenic, anticarcinogenic, and other beneficial properties. The authors concluded that Trigonella has little or no side-effects.

### Mechanism of Action

BTI collaborated w(BTI320 Chewable Tablets), ith an academic laboratory at the University of Minnesota to investigate the mechanism of action of the galactomannans utilized in the SUGARDOWN® formulation (originally called PAZ320 when the study was initiated). Two independent methods in this study demonstrated that the active galactomannan (API), that is the material designated GMα, binds directly to the starch-hydrolyzing enzyme amylase, and inhibits enzymatic activity. This inhibition was not induced by the other gum excipient—designated as GMβ.

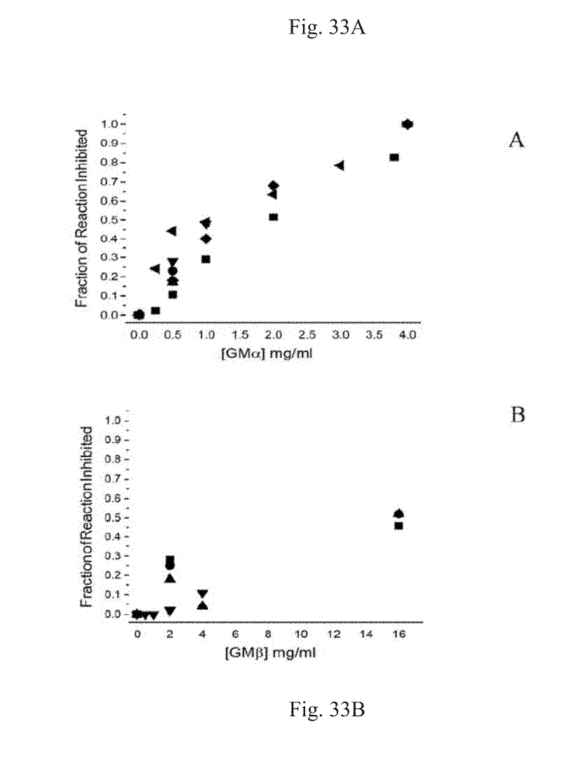

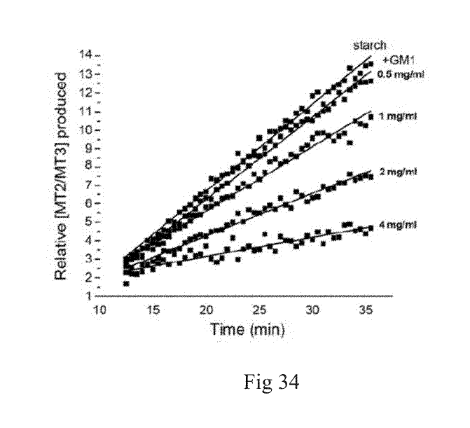

In the first method, a colorimetric assay was used to measure the disappearance of the blue color of iodine intercalated into the starch, a standard assay for amylase hydrolytic activity (Pimstone, 1964). In the second method, product formation of the amylase-mediated hydrolysis of starch was followed by ¹H-NMR (at 3.23-3.27 ppm) as a function of time (FIG. 34). The results of the two independent approaches were consistent with a 50-60% inhibition by GMα at 2 mg/mL and ˜75% inhibition at 3-4 mg/mL (FIG. 33 and FIG. 34; Miller and Mayo, data on file).

The effectiveness of GMα (panel A) and GMβ (panel B) to inhibit starch hydrolysis (1 mg/mL) mediated by porcine pancreatic α-amylase is shown as a function of the concentration of GMα and GMβ. The fraction of reaction inhibited was calculated using U/mL values determined from the iodine-starch assay, with U/mL=(A562 control−A562 sample)/(A562 starch×20 min×0.1 mL reaction volume), a value that can be interpreted as mg of starch hydrolyzed per minute. General solution conditions are 20 mM potassium phosphate, pH 7, 30° C. The different symbols represent separate experiments.

The relative amount of maltose and maltotriose (MT2/MT3) produced during the time course of the amylase-mediated reaction with starch (1 mg/mL) is shown for the initial period of the reaction. Results are shown for starch alone and for starch in the presence of GMα at concentrations of 0.5, 1, 2, and 4 mg/mL, as labeled in the figure. General solution conditions are 20 mM potassium phosphate, pH 7, 30° C. The concentration of MT2/MT3 produced was determined by using a calibration curve generated by acquiring NMR spectra of maltose (MT2) at known concentrations. The slope of each of these curves effectively provides a measure of the apparent rate of reaction.

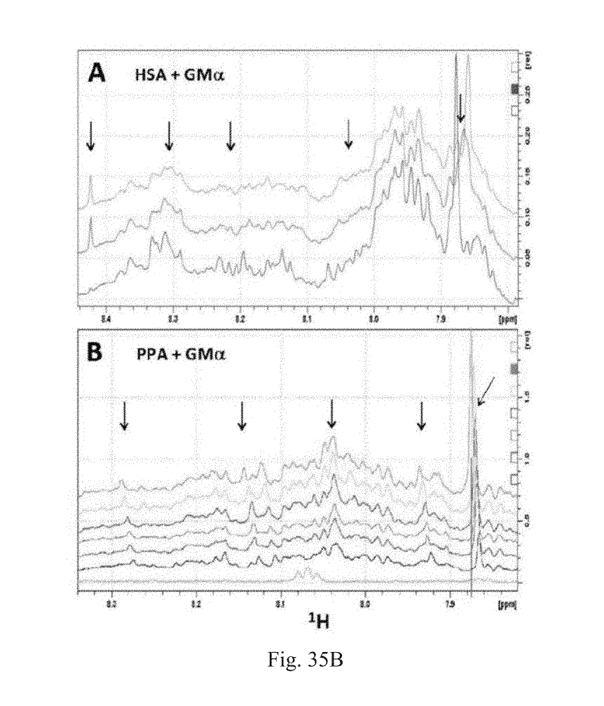

In the same study, the interaction of GMα with amylases from two sources (human salivary amylase and porcine pancreatic amylase) was analyzed by NMR spectroscopy (FIG. 35; Miller and Mayo, data on file). The data clearly show the spectral resonances of the NH/aromatic region (7.8-8.4 ppm) being chemically shifted, suggesting direct binding with histidine residues in the enzyme.

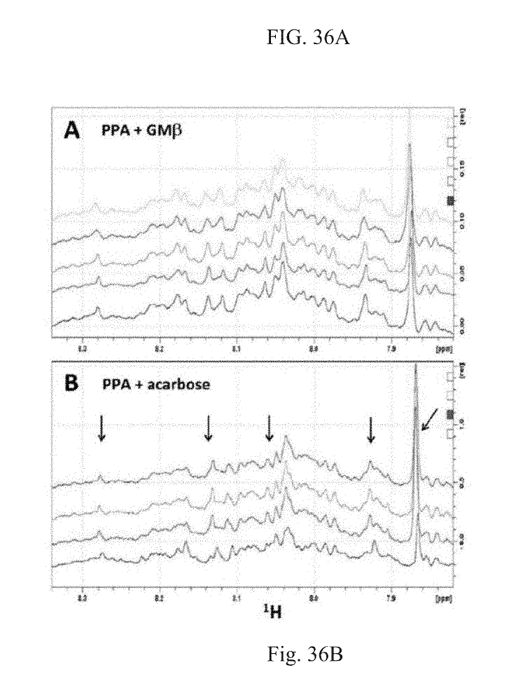

The ¹NMR spectrum of human salivary amylase (HSA, 50 mM) alone is shown in the bottom trace (blue), and spectra of HSA (50 mM) in the presence of GMα at 1 mg/mL (red trace) and 2 mg/mL (green trace) are shown above this trace. (B) The ¹H NMR spectrum of GMα alone (4 mg/mL) is shown in the bottom-most trace, followed by that of porcine pancreatic amylase (PPA, 50 mM) alone, and then spectra of PPA (50 mM) in the presence of GMα at 0.5, 1, 2, 3, 4 mg/mL (upper most trace). Some resonances that shift during the titration are indicated with arrows. General solution conditions are 20 mM potassium phosphate, pH 7, 30° C. As depicted in FIG. 36

The 1H NMR spectrum of PPA (50 mM) alone is shown in the bottom trace of each set of spectra. (A) GMβ was added at concentrations of at 0.5, 1, 2, and 4 mg/mL (upper most trace). (B) Acarbose was added at concentrations of 1, 10, and 50 mM (upper most trace). Some resonances that shift during the titration are indicated with arrows. General solution conditions are 20 mM potassium phosphate, pH 7, 30° C.

More recently, Roberts and colleagues (Roberts et al., 2014) have shown that starch digestion from breads prepared with 5 or 10% of a similar galactomannan was more resistant to salivary or pancreatic amylase digestion in vitro, thus validating the mechanistic findings on the inhibition of amylase-induced release of glucose from starch.

Consequently, the mechanism of action of the galactomannan is through specific inhibition of carbohydrate hydrolyzing enzymes at the molecular level, by interacting with the active site of amylase.

### Safety and Efficacy Range of Toxicity

Raw materials labeled as GRAS, food grade carbohydrates and food grade polysaccharides; considered not to be a toxic hazard in the quantities available through normal exposure or package size.

TABLE 3
Pharmacological Properties of SUGARDOWN ® versus
Other Mannan Products

| Comparison | Other | |
|---|---|---|
| Factors | Mannans | SUGARDOWN ® |
| Efficacy in | Poor | 100% |
| human | | |
| Purity | 30% pure | >85% pure |
| Formulation | Pill, Powder, Gel | Chewable Tablet |
| Toxicity | Has the potential | Safe up to 20 tablets |
| | to cause death; some | a day: two tablets |
| | banned by the FDA | before a meal will |
| | | attenuate blood |
| | | glucose increases |
| | The mannans are | Does not lower glucose |
| | designed to lower | in the blood but it |
| | glucose in the | prevents elevation of |
| | blood 100% | glucose post meal |
| Molecular | Mixture of many | Single molecular |
| structure | ingredients | entity |

SUGARDOWN®, also known as PAZ320 and BTI320, is derived from galactomannan which acts by blocking key carbohydrate hydrolyzing enzymes, including α-amylase, maltose, lactose, and sucrose, in the gastrointestinal tract. SUGARDOWN® also binds to ingested polysaccharides, thereby slowing absorption with each meal, reducing post-prandial glucose excursion (Trask et al., 2014). As a secondary benefit, galactomannan is an appetite suppressant which facilitates meal portion control. The mechanism of action for SUGARDOWN® (BTI320 Chewable Tablets), is similar to acarbose, an alpha glucosidase inhibitor, which has been shown to improve glycemic control and has been approved for the prevention of diabetes in China (Yang et al., 2001; Chan et al., 1998). SUGARDOWN® is currently distributed as a dietary supplement.

The effects of SUGARDOWN® (BTI320 Chewable Tablets), on post-prandial glucose parameters were examined in four separate studies (two Phase 1 and two Phase 2 studies). Data from these studies suggested that SUGARDOWN® (BTI320 Chewable Tablets), is profoundly different to the anti-diabetic drugs currently available in the market, such as metformin or repaglinide.

Unlike systemic oral hypoglycemics, SUGARDOWN® (BTI320 Chewable Tablets), has not been shown to have influence on internal organs, like the pancreas or the liver. SUGARDOWN® (BTI320 Chewable Tablets), does not lower serum glucose levels by systemic or tissue-based mechanisms. Glucose reduction in the blood is achieved by slowing down the release of glucose from sucrose and other glycemic carbohydrates (e.g., starch) and preventing the accumulation of glucose in the blood after a meal. SUGARDOWN® (BTI320 Chewable Tablets), does not prevent the absorption of sugar into the blood from the intestine. It is not a carbohydrate blocker and has not been shown to have any influence on the intestine itself (no interaction or adhesion). Mechanistically, SUGARDOWN® (BTI320 Chewable Tablets), blocks the enzymes that hydrolyze polysaccharides in food.

Acarbose is the only prescription drug on the market that has a similar activity as SUGARDOWN®. Acarbose delays digestion of complex carbohydrates and disaccharides to absorbable monosaccharides by reversibly inhibiting α-glucosidases within the intestinal brush border, thereby attenuating postprandial glucose excursion. Clinical trials have demonstrated that acarbose generally improves glycemic control in patients with non-insulin dependent diabetes mellitus (NIDDM) managed with diet alone, or with other anti-diabetic therapy, as evidenced by decreased PPG and Hb_{A1c}, levels. In preliminary animal studies, acarbose appeared to delay or prevent the development of long-term vascular complications of diabetes (Balfour and McTavish, 1993); these data were confirmed in patients with type 2 diabetes (Hanefeld et al., 2004). Further, acarbose, which has the same mechanism of action of SUGARDOWN®, has been shown to delay progression to type 2 diabetes in pre-diabetic patients (Chiasson et al., 2002). Statistical analyses performed on the two showed that SUGARDOWN® (BTI320 Chewable Tablets), is better and has less side effects compared with acarbose. High incidence of gastrointestinal disturbances such as flatulence, abdominal distension, borborygmus, and diarrhea are associated with the consumption of acarbose.

Where Hb_{A1c}, is the ‘gold standard’ and commonly used to monitor long term glycemic control and guide medication adjustments, it can only reflect the change in fasting glucose and blood glucose level over a past 3-month period. A monitoring system that records and provides blood glucose level information in real time would precisely monitor the efficacy in post-prandial glucose excursion and explore the safety in averting hypoglycemic events secondary to systemic anti-diabetic drugs. To date, CGMS is the only reliable method to capture the time when blood glucose is in range by highlighting the magnitude of glycemic excursions, and capturing hypoglycemic events. CGMS helps type 2 diabetes patients identify changing glucose levels in real time and helps them manage their daily glucose levels to avoid hypoglycemia and improve diabetes control.

It is to be understood that the examples that follow are provided for explanatory purposes and are not to be construed as limiting, and that numerous variations and modifications will be evident to those skilled in the art and may be made without departing from the spirit and scope of the disclosure.

### EXAMPLE 1

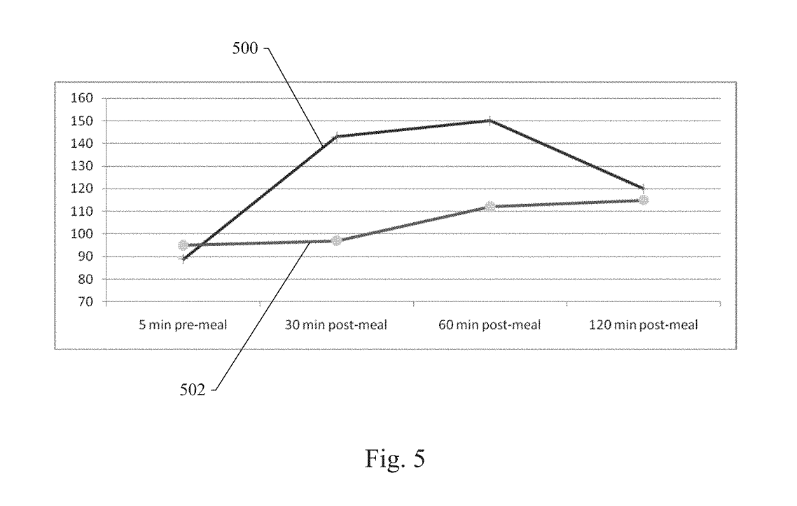

In an illustrative example, a subject suspected of pre-diabetic condition was given a meal containing about 400 kcal of combination of starch and sugar. The subject's blood glucose was monitored over a 2 hour period post meal. A graph of the subject's blood glucose levels according to an illustrative embodiment is described with reference to FIG. 5. As illustrated in FIG. 5, the first data points 500 are for non-treatment condition, while the second data points 502 are for the treatment condition. In this illustrative embodiment, the subject consumed about 6 grams of a mixture of purified mannan polysaccharide fibers prior to the meal. The results of a comparison between the first data points 500 and the second data points 502 clearly illustrate lower glucose levels over the 2 hours of testing indicating a drop in glycemic index. Thus, the consumption of about 6 grams of a mixture of purified mannan polysaccharide fibers results in lower glucose levels.

### EXAMPLE 2

In a further illustrative example, a study comparing the short-term postprandial blood glucose and insulin responses produced by two test meals containing purified mannan polysaccharide fibers, compared to the effects produced by an equal-carbohydrate portion of a control meal of plain white rice was performed. The study used a repeated-measures design, such that every subject consumed each meal on two separate occasions, completing a total of six separate test sessions. Each subject completed their test sessions on separate weekday mornings at a similar time of day, as close as possible to the time they would normally eat breakfast.

### Subjects

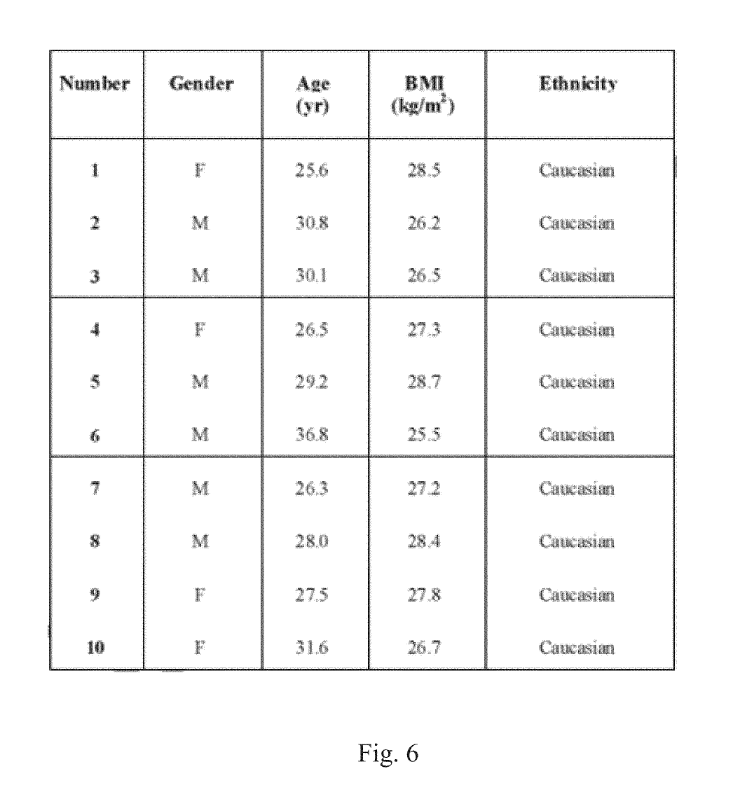

The subjects' relevant details including gender, age, body mass index (BMI), and ethnicity are listed in FIG. 6. As illustrated in FIG. 6. The subjects included ten healthy, non-smoking, overweight or obese subjects (4 females, 6 males). The mean±SD age of the subjects was 29.2±3.3 yr (range: 25.6-36.8 yr), and their mean±SD body mass index value was 27.3±1.1 kg/m² (range: 25.5-28.7 kg/m²).

All of the subjects met the following criteria: are aged between 25-65 years; non-smokers; have a stable body weight within the overweight weight range for their height (BMI values greater than 25 kg/m²); have normal dietary habits and are and have not been dieting or eating in an overly restrictive fashion within the past 3 months; have a regular pattern of low to moderate physical activity; are able to fast for greater than or equal to 10 hours the night before each test session; are able to refrain from eating a legume-based evening meal or drinking alcohol the day before each test session; find the test foods suitable for consumption within 12 minutes; are covered by social security or a similar system; are not taking any treatment for anorexia, weight loss, or any form of treatment or medication likely to interfere with metabolism or dietary habits; signed the informed consent form for the study; do not have any clinically significant physical or mental illness; are not suffering from a food allergy or serious food intolerance; are not regularly taking prescription medication other than standard contraceptive medication; are not females who are currently pregnant, breast-feeding, trying to become pregnant or using an acceptable contraceptive; are not participating in another clinical trial or participated in another clinical trial within the last week; are not undergoing general anesthesia in the month prior to inclusion; are not in a situation, which in the investigator's opinion could interfere with optimal participation in the present study or could constitute a special risk for the subject.

### Test Foods

Each rice-based test meal was served to a subject in a fixed portion containing 50 grams of available carbohydrate. All three test meals consisted of the same portion of cooked Jasmine rice (for example, Sun Rice® Jasmine Fragrant Rice, Ricegrowers Limited, NSW, Australia) served with 250 mL of plain water. Two of the test meals also included the consumption of either three (3) or six (6) purified mannan polysaccharide fiber tablets (BTI320 Chewable Tablets), with 250 mL plain water 10 minutes prior to the consumption of the rice-based meal. A glass of 250 mL of water was consumed 10 minutes prior to the consumption of the rice meal for the control meal (“RICE”).

The composition of each of the purified mannan tablets (BTI320 Chewable Tablets), according to the disclosure included about 2.0 g of purified mannan polysaccharide and about 1.5 g of Sorbitol. Therefore, the test meal in which three purified mannan tablets were consumed (“RICE+3”) included about 6.0 g of purified mannan polysaccharide and about 4.5 g of Sorbitol. The test meal in which six purified mannan tablets were consumed (“RICE+6”) included about 12.0 g of purified mannan polysaccharide and about 9 g of Sorbitol.

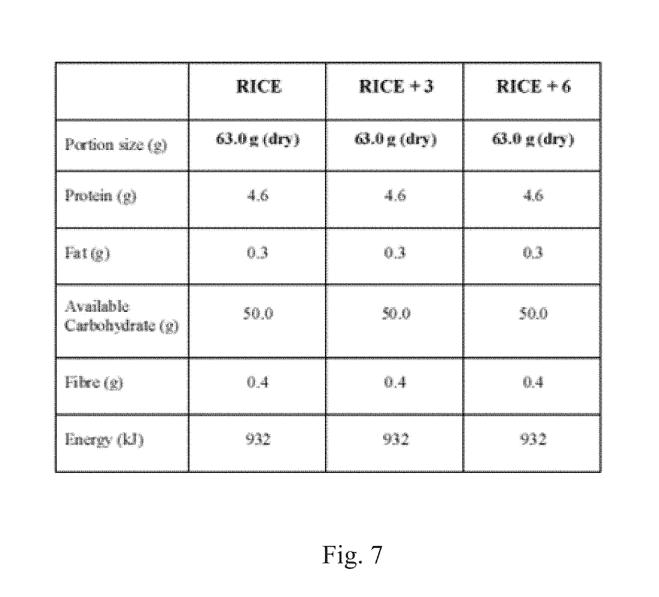

The macronutrient contents of the equal-carbohydrate portions of the three test meals (RICE, RICE+3, and RICE+6) are illustrated in FIG. 7, calculated using the manufacturer's data. As illustrated in FIG. 7, all three meals included a portion size of about 63 g of dry rice including about 4.6 g of protein, about 0.3 g of fat, about 50 g of available carbohydrate, about 0.4 g of fibre, and about 932 kJ of energy.

### Administration of Test Foods

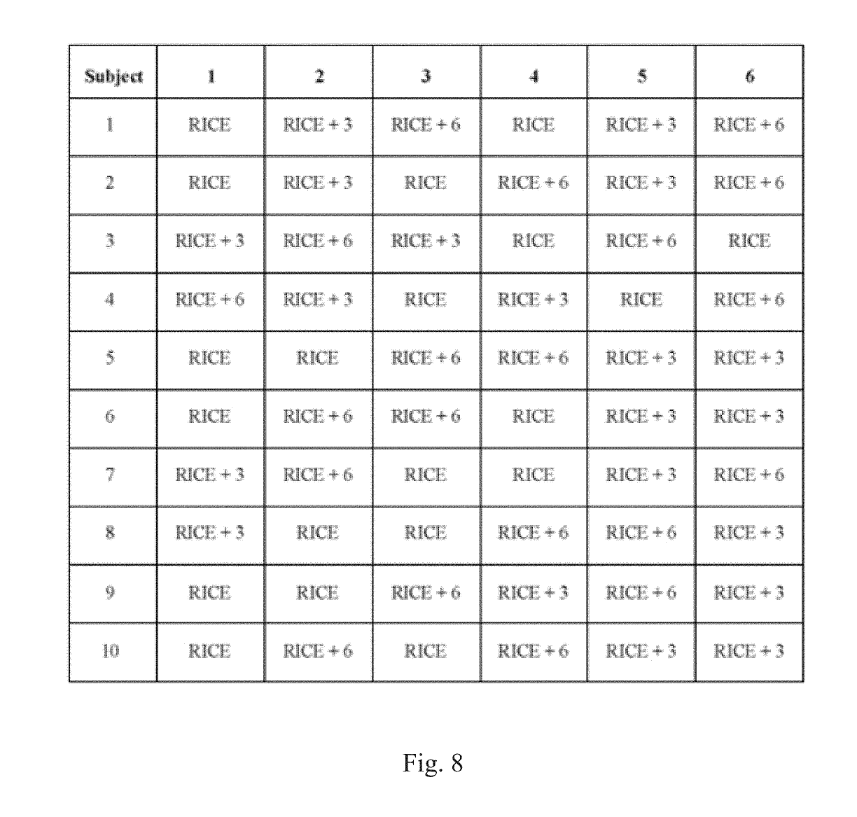

The three rice test meals (RICE, RICE+3, and RICE+6) were each consumed by the 10 subjects on two separate occasions. Therefore, each subject completed six separate test sessions. Each of the six test meals was presented to the subjects in a random order according to the list illustrated in FIG. 8. Ten minutes prior to the consumption of the rice test meal, the subjects were required to consume either 250 mL of water (control RICE meal), 3 purified mannan tablets (BTI320 Chewable Tablets), according to the disclosure with 250 mL water (RICE+3 meal) or 6 purified mannan tablets (BTI320 Chewable Tablets), according to the disclosure with 250 mL water (RICE+6). The test meals were all served to the subjects on standard white china plates without any commercial packaging. Therefore, the subjects can be considered to have been blind to the exact identity of rice or purified mannan tablets included in the test meals.

Each rice portion was prepared shortly before consumption according to the manufacturer's instructions. A test portion of dry rice was individually cooked on the stovetop using a gentle boil method in excess water. The rice portion was stirred occasionally during the cooking process, before being drained and served to a subject in a white china bowl. Each rice portion was served together with 250 mL of plain water. As soon as the subjects commenced eating, a stopwatch was started to time the progress of the two-hour experimental session. The subjects were instructed to consume all of the food and fluid served to them at a comfortable pace within 12 minutes.

### Experimental Protocol

The day before each test session, the subjects were required to refrain from drinking alcohol for the entire day and to avoid unusual levels of food intake and physical activity. In the evening, they were required to eat an evening meal based on a low-fat, carbohydrate-rich food, other than legumes, after which the subjects were required to fast for at least 10 hours overnight until the start of their test session the next morning. During the fasting period, they were allowed to drink only water.

The next morning the subjects reported to the research centre in a fasting condition. The researchers first checked that each subject was feeling well and had not taken any medication since the previous test session, and had been able to comply with all of the preceding experimental requirements. Each subject's body weight was then recorded (subjects clothed but without jackets and shoes), after which they warmed a hand in a bucket of hot water for 1-2 minutes. The first of two fasting finger-prick blood samples (−10 min) was then obtained from a fingertip (≥0.7 mL of capillary blood—depending on blood flow and haematocrit level) using a sterile automatic lancet device (for example, Safe-T-Pro®, Boehringer Mannheim, Germany). The subject was then given either rice with 250 mL of water (control RICE meal), rice with 3 purified mannan tablets and 250 mL water (RICE+3 meal), or rice with 6 purified mannan tablets and 250 mL water. They were required to consume this test portion within 5 minutes. After 10 minutes, the subjects reheated their hand in hot water for another minute, after which another fasting blood sample was taken (0 min).

After this fasting blood sample was obtained, the subjects were seated at a large table in a quiet room and they were served a fixed portion of white rice, which they consumed together with 250 mL of water at a comfortable pace within 12 minutes. A stopwatch was started for each subject as soon as they began eating (0 min). The subjects were instructed to consume all of the water and food served to them, after which they were required to remain seated at the research centre and refrain from additional eating and drinking for the next two hours. Additional finger-prick blood samples were collected 15, 30, 45, 60, 90 and 120 minutes after eating had commenced. The subjects reheated their hands for 1-2 minutes in hot water before each blood sample was required. Therefore, a total of eight blood samples were collected from each subject during a test session. After completing the 120-minute test session, the subjects were free to consume some refreshments before leaving the research centre.

### Determination of Plasma Glucose and Insulin Concentrations

Each blood sample was collected into a 1.5-mL plastic micro-centrifuge tube containing 10 international units (IU) of an anticoagulant, heparin sodium salt (for example, Grade II, Sigma Chemical Company, Castle Hill, NSW, Australia). Immediately after collection, the blood sample was mixed with the anticoagulant by gently inverting the tube, and centrifuged at 12,500×g for 0.5-1.0 minute at room temperature. The plasma was then immediately transferred into a labeled, uncoated plastic micro-centrifuge tube and then stored at −20° C. until analyzed.

### Measurement of Plasma Glucose Concentrations

The plasma glucose concentrations were measured in duplicate using a Roche/Hitachi 912® automatic spectrophotometric centrifugal analyzer (for example, Boehringer Mannheim Gmbh, Mannheim, Germany) employing the glucose hexokinase/glucose-6-phosphate dehydrogenase enzymatic assay (for example, Boehringer Mannheim Australia, Castle Hill, NSW, Australia). All of the eight blood samples for an individual subject's test session were analyzed within the same assay run. Each run was performed with standard calibrators and internal controls (for example, CFAS, Precinorm S, and Precinorm U, Boehringer Mannheim, Australia). If the duplicate values for a blood sample differed by more than 0.3 mmol/L, the sample was reanalyzed another 2 times, and the 2-3 most similar concentrations were used to calculate an average plasma glucose concentration for that sample.

### Measurement of Plasma Insulin Concentrations

The plasma insulin concentrations were measured using a solid phase antibody-coated tube radioimmunoassay kit (for example, Diagnostic Products Corporation, Los Angeles, Calif., USA). All of the blood samples collected from each individual subject throughout the entire study were analyzed within the same assay run using internal controls. The final insulin concentration of each plasma sample was calculated by converting the radioactive counts observed, using a calibration curve created by standards of known insulin concentrations. Two sets of standards were used in each assay run.

### Data Analysis

The average value of the two duplicate plasma glucose concentrations recorded for each blood sample was used as subjects' blood glucose concentrations for the eight time points of each two-hour test session. For each subject, the incremental area under the two-hour plasma glucose response curve (iAUC) for each test meal was calculated using the trapezoidal rule with the baseline, fasting value truncated at zero. The baseline value was the average concentration of the two fasting blood samples (−10 and 0 minutes). Any negative area below the fasting level was ignored. The iAUC values allow the comparison of the integrated effects of the test meals over a fixed time period. The incremental area under the plasma insulin response curve for each subject's test meals was calculated using the same method listed above for the plasma glucose iAUC.

The raw plasma glucose and plasma insulin results were typed into a spreadsheet (for example, Microsoft® Excel 2004 software, Microsoft Corporation) as they were obtained during the course of the study. Once data entry was completed, the incremental areas under the curve for the plasma glucose and insulin responses were calculated. The data in the spreadsheets were then transferred to another computer program file (for example, Statview® software, version 4.02, 1993, Abacus concepts Inc, Berkley, Calif., USA), in order to calculate descriptive statistics for the glucose and insulin iAUC responses (including the mean, median, standard deviation (SD), and standard error of the mean (SEM)).

Repeated-measures analysis of variance (ANOVA) was used to determine whether there were any significant differences amongst the mean glucose and insulin iAUC responses of the three rice test meals. If a statistically significant product-effect was found, a post-hoc multiple comparisons test was performed in order to identify the specific significant differences. For normally distributed data, the Fisher PLSD test was used as the post-hoc test.

### Results

No serious adverse effects were reported or observed during the study and none of the subjects reported taking any medication other than the purified mannan tablets. Each two-hour experimental session proceeded without incident. Similarly, none of the subjects prematurely departed the study. Two subjects reported minor gastrointestinal discomfort following a 2-hour experimental session containing the highest (6 tablets) dose of purified mannan tablets. These subjects reported mild stomach pain and/or diarrhea on the afternoon of the test session containing the 6 tablet dosage of purified mannan. All ten subjects reported that the larger dose of purified mannan tablets was difficult to consume due to the taste and size of the tablets.

### Plasma Glucose Responses

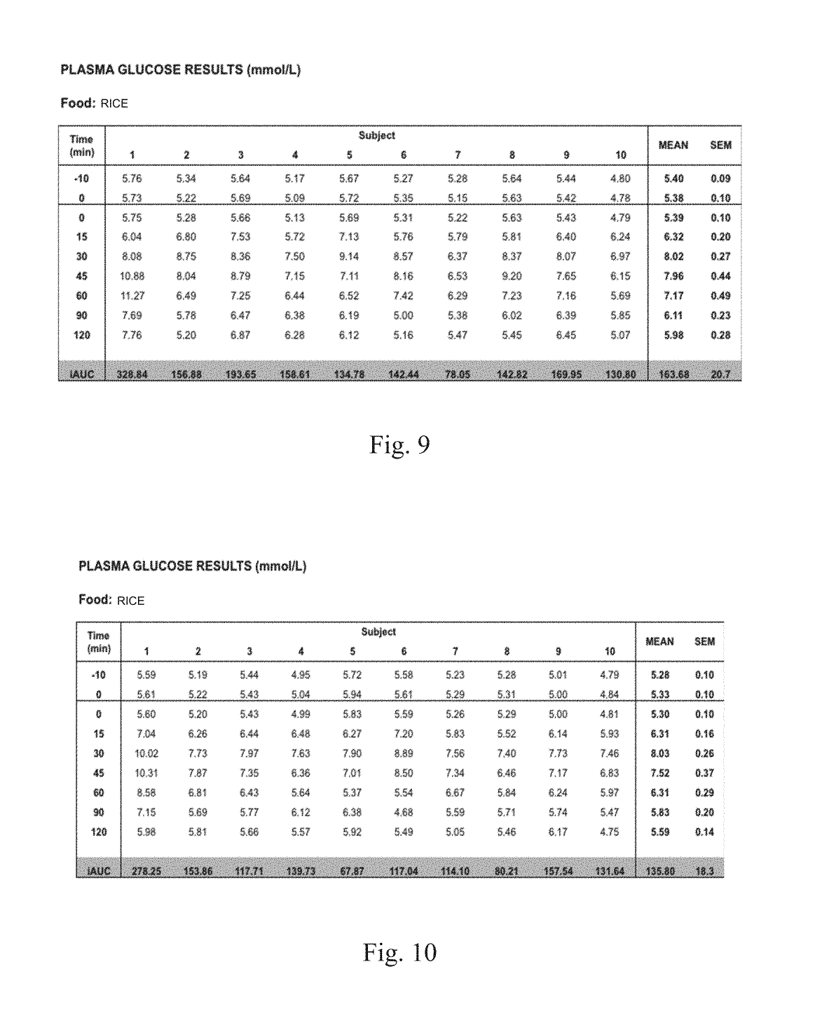

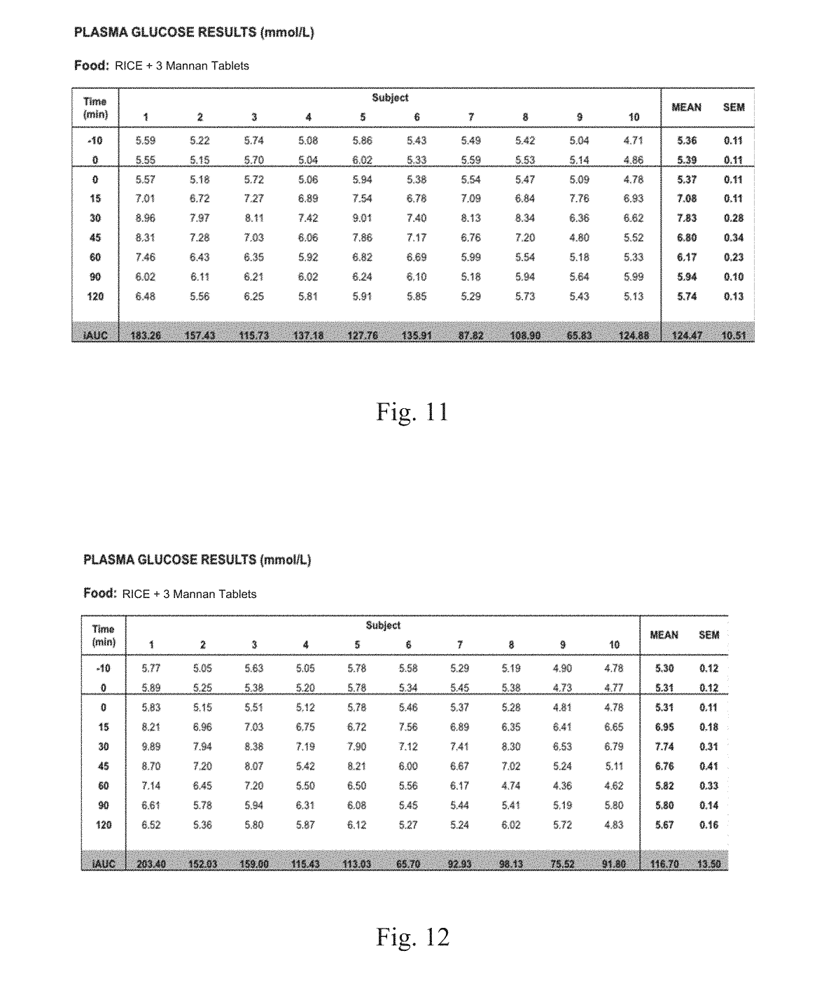

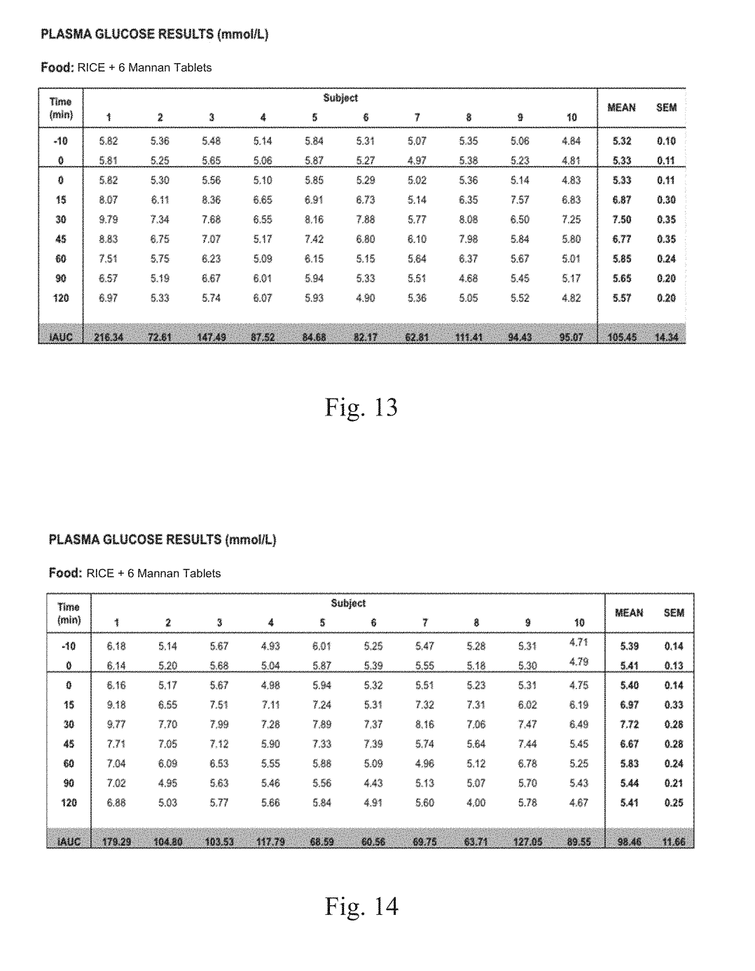

The 10 subjects' individual blood glucose concentrations for each test meal and their corresponding plasma glucose iAUC values are illustrated in FIGS. 9-14. FIGS. 9 and 10 illustrate the subjects' individual blood glucose concentrations for the RICE meals. FIGS. 11 and 12 illustrate the subjects' individual blood glucose concentrations for the RICE+3 meals. FIGS. 13 and 14 illustrate the subjects' individual blood glucose concentrations for the RICE+6 meals.

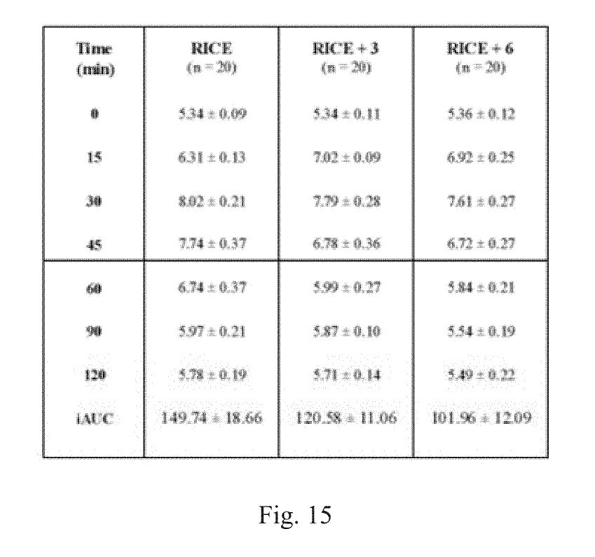

The control meal (RICE) produced the highest peak plasma glucose concentration at 30 minutes and the greatest overall glycemic response, referring to the glucose iAUC values illustrated in FIG. 15. FIG. 15 illustrates the mean±SEM absolute plasma glucose concentrations for the eight blood samples (mmol/L) collected during the two-hour test sessions for the three test meals (repeated twice) and the mean incremental areas under the foods' two-hour plasma glucose response curves (iAUC). The results listed at 0 minutes are the mean values of two fasting blood samples (−10 and 0 min).

The overall glycemic response produced by the two test meals containing Rice and purified mannan tablets (BTI320 Chewable Tablets), was similar throughout the 120-minute experimental period. Both of the RICE+3 and RICE+6 test meals produced a steady rise in plasma glucose to a moderate peak response at 30 minutes, followed by a gradual decline in glucose response between 30-120 minutes. The RICE+6 meal produced a smaller plasma glucose concentration at each time-point throughout the 120-minute experimental period, resulting in a lower overall glycemic response compared to the RICE+3 meal.

### Plasma Insulin Responses

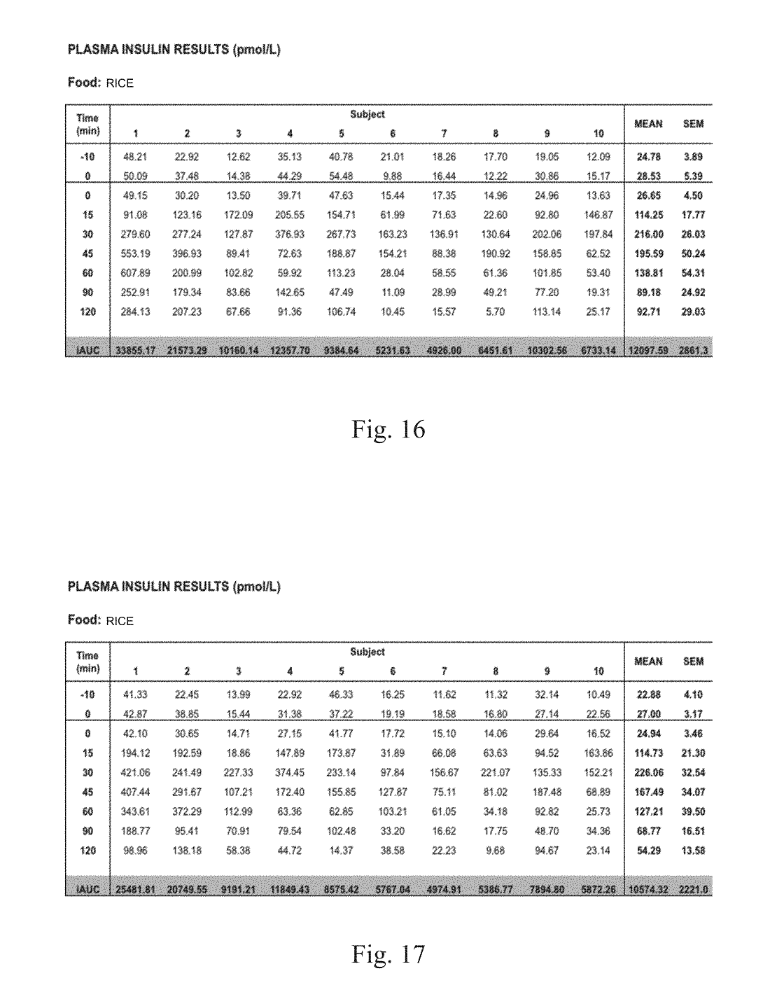

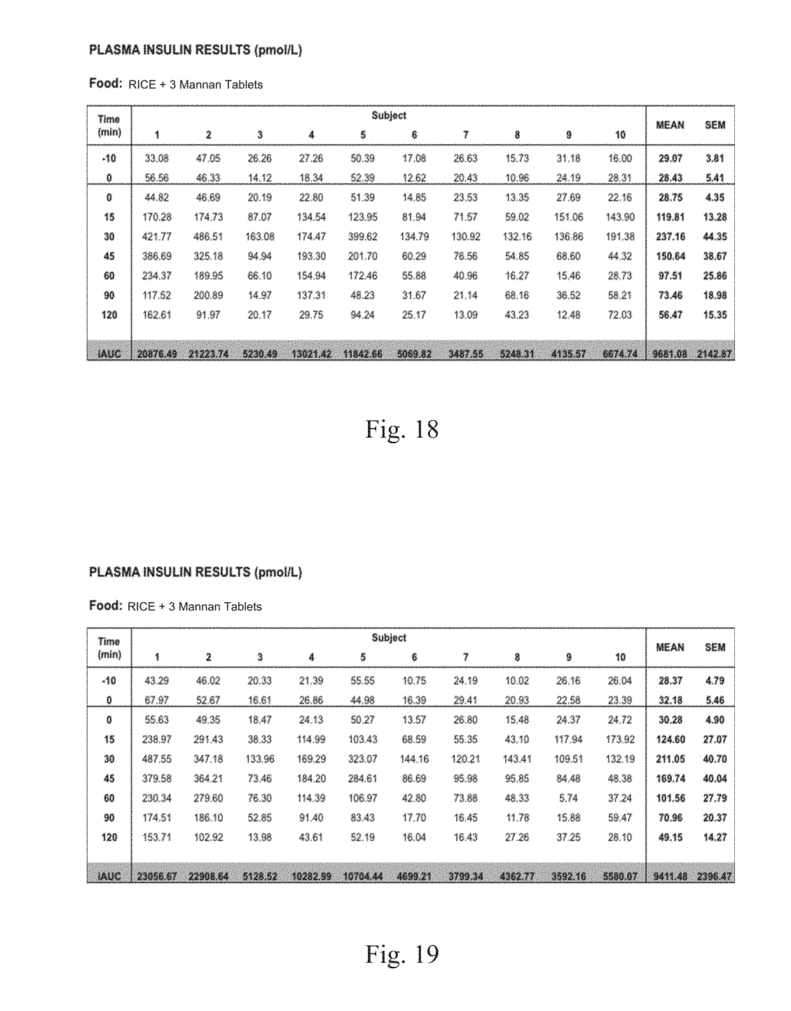

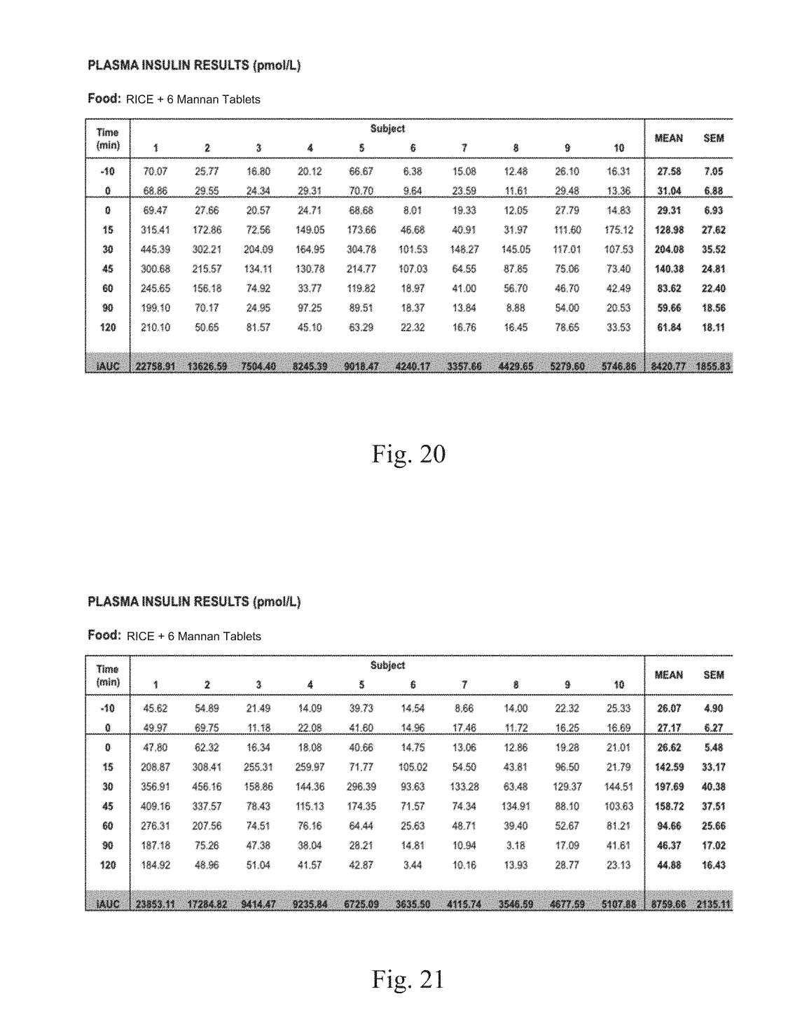

The 10 subjects' individual plasma insulin responses and insulin iAUC values for the test meals are illustrated in FIGS. 16-21. FIGS. 16 and 17 illustrate the subjects' individual plasma insulin concentrations for the RICE meals. FIGS. 18 and 19 illustrate the subjects' individual plasma insulin concentrations for the RICE+3 meals. FIGS. 20 and 21 illustrate the subjects' individual plasma insulin concentrations for the RICE+6 meals.

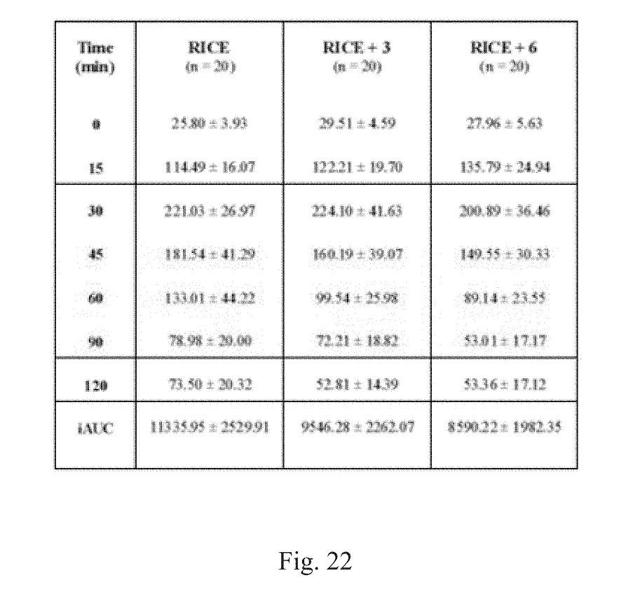

The average plasma insulin concentrations for the three rice meals are illustrated in FIG. 22. FIG. 22 illustrates the mean±SEM absolute plasma insulin concentrations for the eight blood samples (pmol/L) collected during the two-hour test sessions for the test meals and the mean incremental areas under the two-hour plasma insulin response curves (iAUC). The results listed at 0 minutes are the mean values of two fasting blood samples (−10 and 0 min).

As expected due to its high glycemic response, the control food (RICE) produced a large rise in plasma insulin concentration and the largest overall plasma insulin response, referring to the insulin iAUC values illustrated in FIG. 22. The insulinemic responses produced by the two RICE+3 and RICE+6 test meals was similar throughout the experimental period. The two meals both produced a steady rise in plasma insulin concentration to a peak response at 30 minutes followed by a gradual decline in insulin concentration between 30-120 minutes. Similar, to the corresponding glycemic response, the RICE+6 meal produced a lower peak and overall insulin response compared to the RICE+3 meal. The average plasma insulin levels for all three rice meals remained above the fasting baseline level at the completion of the 120-minute experimental period.

The Average iAUC Responses

The postprandial glucose and insulin iAUC responses varied among the subjects that participated in the study. This variation between different peoples' responses to the same food is normal and is due to a number of factors, including different rates at which the subjects ingested the food, differences in the nutrient content of the individual test food portions, differences in the subjects' carbohydrate metabolism, and lifestyle and genetic factors.

Parametric statistical tests (for example, repeated-measures ANOVA and the Fisher PLSD test) were used to determine whether there were any significant differences among the plasma glucose and insulin iAUC responses for the rice test meals.

The one-factor repeated-measures ANOVA of the rice meals' average plasma glucose iAUC responses indicated that a significant difference existed amongst the mean iAUC values (p=0.0001). The results of the post-hoc test (for example, the Fisher PLSD test) showed that the mean iAUC response for the control meal (RICE) was significantly greater than the mean glucose responses for the RICE+3 tablets (p<0.01) and the RICE+6 tablets (p<0.001). The mean plasma glucose iAUC response for the RICE+3 tablets meal was also found to be significantly higher than the mean glucose response for the RICE+6 tablets (p<0.05).

The one-factor repeated-measures ANOVA of the rice meals' average plasma insulin responses indicated that a significant difference existed amongst the mean iAUC responses (p=0.0009). The mean plasma insulin iAUC response of the RICE meal was significantly greater than the mean insulin responses of the RICE+3 tablets meal (p<0.05) and the RICE+6 tablets meal (p<0.001). No significant difference was detected between the mean plasma insulin responses of the two test meals containing the purified mannan tablets (BTI320 Chewable Tablets).

Relationship Between the Test Foods' Glucose and Insulin iAUC Responses

Linear regression analysis was used to determine the degree to which the individual subjects' plasma glucose and insulin responses for the test meals were associated. In general, the rice test meals' glucose responses were significantly associated with their corresponding insulin responses (r=0.78, n=60, p=0.0001).

### Conclusion

This study shows that the consumption of tablets having a composition including purified mannan polysaccharide fiber according to the disclosure prior to a high carbohydrate food significantly reduces the postprandial glucose and insulin responses to that meal. The lower dose of purified mannan (BTI320 Chewable Tablets), the 3 tablets containing 6 g mannan polysaccharide and 4.5 g Sorbitol, resulted in a 19% reduction in postprandial glucose and 16% decrease in postprandial insulin response compared to the white rice consumed alone. The higher dose of purified mannan (BTI320 Chewable Tablets), the 6 tablets containing 12 g mannan polysaccharide and 9 g Sorbitol, produced a 32% reduction in the 2-hr glucose response and a 24% reduction in the postprandial insulin response compared to the white rice control meal.

### EXAMPLE 3

### Toxicity Testing

In an illustrative embodiment, the purification processes described above eliminate dioxins below 0.01 mg/kg, which is considered safe for human consumption. High levels of pentachlorophenol and dioxins have been found in certain batches of guar gum originating in or consigned from India, about 1000 times the level of what can be considered as normal background contamination. Such contamination constitutes a threat to public health if no measures are taken to avoid the presence of pentachlorophenol (PCP) and dioxins in guar gum. In an illustrative embodiment, testing demonstrates that the product or purified mannan polysaccharide fiber according to the disclosure does not contain more than 0.01 mg/kg pentachlorophenol (PCP). Similarly, the process is validated for microbial toxins and heavy metals to make the product safe for human and non-human consumption.

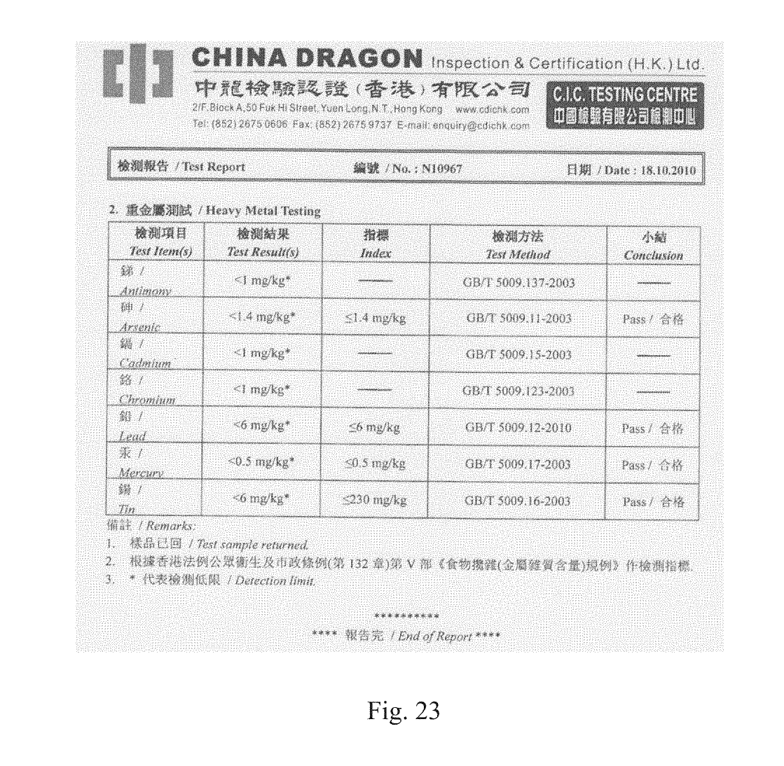

In an illustrative embodiment, the purified mannan polysaccharide fiber according to the disclosure was tested for heavy metals. As illustrated in FIG. 23, a chewable tablet (BTI320 Chewable Tablets), containing about 2 grams of purified mannan polysaccharide fiber according to the disclosure was tested for antimony using a GB/T 5009.137-2003 test method. The results indicate that the chewable tablet (BTI320 Chewable Tablets), contains less than about 1 mg/kg of antimony. The chewable tablet (BTI320 Chewable Tablets), was tested for arsenic using a GB/T 5009.11-2003 test method. The results indicate that the chewable tablet contains less than about 1.4 mg/kg of arsenic. The chewable tablet (BTI320 Chewable Tablets), was tested for cadmium using a GB/T 5009.15-2003 test method. The results indicate that the chewable tablet contains less than about 1 mg/kg of cadmium. The chewable tablet (BTI320 Chewable Tablets), was tested for chromium using a GB/T 5009.123-2010 test method. The results indicate that the chewable tablet(BTI320 Chewable Tablets), contains less than about 1 mg/kg of chromium. The chewable tablet (BTI320 Chewable Tablets), was tested for lead using a GB/T 5009.12-2010 test method. The results indicate that the chewable tablet (BTI320 Chewable Tablets), contains less than about 6 mg/kg of lead. The chewable tablet (BTI320 Chewable Tablets), was tested for mercury using a GB/T 5009.17-2003 test method. The results indicate that the chewable tablet contains less than about 0.5 mg/kg of mercury. The chewable tablet (BTI320 Chewable Tablets), was also tested for tin using a GB/T 5009.16-2003 test method. The results indicate that the chewable tablet contains less than about 6 mg/kg of tin.

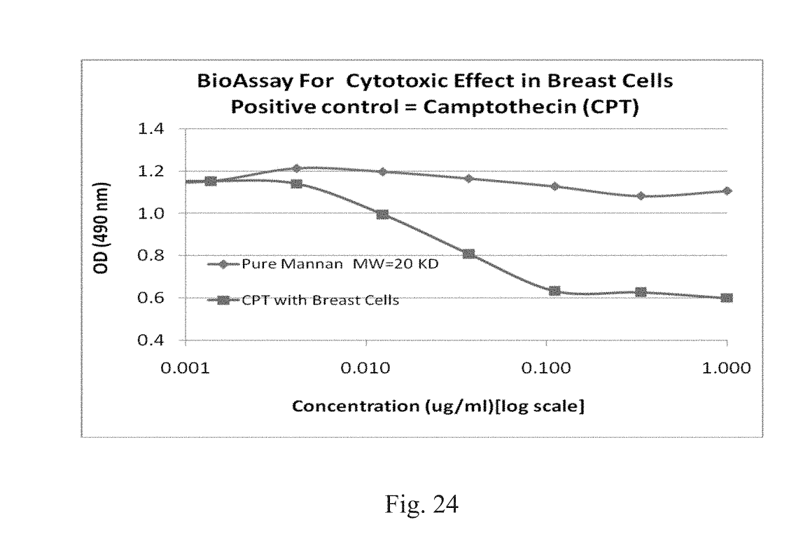

In an illustrative embodiment, the purified mannan polysaccharide fiber according to the disclosure was tested for cytotoxicity using, for example, a culture of breast tissue cells. The cytotoxicity bioassay procedure included re-suspending the cells in assay culture media containing about 0.25% Heat Inactivated Fetal Bovine Serum (HI-FBS) (for example, Gibco lot #1297785) and 4× Penicillin Streptomycin (Pen/Strep). After re-suspending the cells, about 100 μL of the growing culture cells was transferred into each well of an assay plate (5,000 cells/well). Test samples were serially diluted in assay media without Pen/Strep in a test tube in duplicate. About 100 μl of serial diluted was added to the cells. The final volume of each well was about 200 μl, containing about 2× Pen/Strep. The cells were then incubated for about 137 hours. Following incubation, about 20 μl of Promega Substrate Cell Titer 96 Aqueous One Solution Reagent was added to each well. The samples were then incubated as about 37 degrees Celsius and the optical density (OD) at 490 nm was determined. The results were graphed and the ID50 (Inhibition concentration causing 50% growth reduction) was calculated. The results are illustrated in graphical form in FIG. 24. As illustrated in FIG. 24, the purified mannan polysaccharide has no cytotoxicity. Camptothecin (CPT) with breast tissue cells was used as a control.

In an illustrative embodiment, the purified mannan polysaccharide fiber according to the disclosure was tested for neurotoxicity. The neurotoxicity assays were conducted using glioma cell (for example, ATCC® CCL-107™) and neuroblastoma cell (for example, ATCC® HTB-11™). The cells that previously were stored at about −200 degrees Celsius were reconstituted and cultured in assay media (for example, 5% HI-FBS—Gibco lot #1393129). The cells were re-suspended in assay media free of cytokines containing 5% HI-FBS (for example, Gibco lot #1393129) at 20,000 cells/100 μL. About 100 μL of the cells was transferred to each well of an Assay Plate (for example, a 96-well format). About 20 μL of Nerve Growth Factor solution was added to each well and incubated for about 20 hours at about 37 degrees Celsius. Nerve Growth Factor solution, for example Brain-derived neurotrophic factor (BDNF) in growth media contains 5% HI-FBS for optimum growth.

In a separate plate, a sample was serially diluted in duplicate in dilutions of 1:3 in assay media. About 100 μL was transferred to the cells in each well in the Assay Plate and incubated for about 24 hours at about 37 degrees Celsius. About 204, of Promega' CellTiter 96® AQueous One Solution was added to each well and incubated at about 37 degrees Celsius. The results at OD 490 nm were determined. Proliferation data was analyzed versus a negative and positive (10 ug/mL Methotrexate added) controls. The IC50 value was then determined by Probit regression analysis. The results indicated that the purified mannan polysaccharide fiber has no neurotoxicity. The purified mannan polysaccharide fiber has no IC50 value established at concentrations of over 5 mg/mL, where as known neurotoxins and cytotoxins have an IC50 in the micro and nano grams/mL levels.

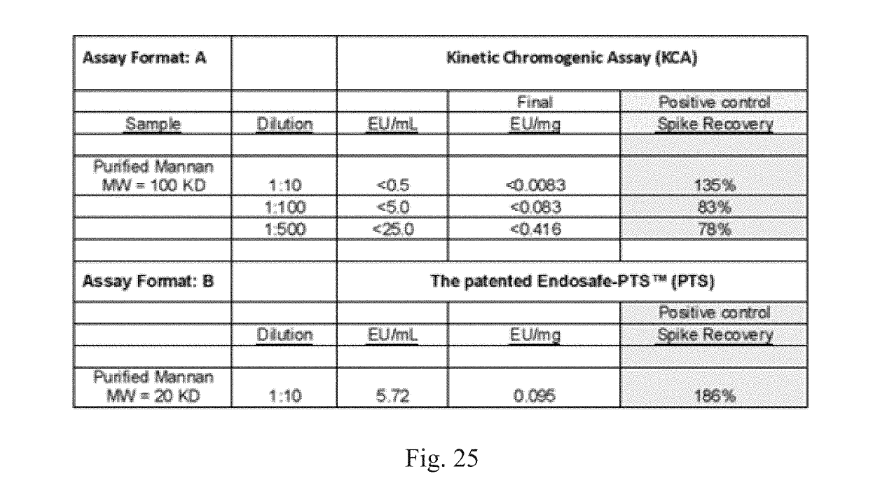

In an illustrative embodiment, the purified mannan polysaccharide fiber according to the disclosure was tested for microbial toxins. An assay for total Microbial toxins was conducted using Endosafe®-PTS (Charles River laboratories). Critical endotoxin test results are crucial for the confirmation of safe manufacture and necessary for release of safe therapeutic product. A handheld spectrophotometer that utilizes FDA-licensed disposable cartridges for accurate, convenient endotoxin testing was used. With test results in just 15 minutes, manufacturing and release can rapidly move forward without delay. The assay illustrated in FIG. 25 of purified mannan polysaccharide fiber indicates that total microbial endotoxins are below the limit of detection of the assay, for example less than 0.5 EU/mL, and less than 0.0083 EU/mg.

While the compositions, systems, processes, and methods disclosed herein have been described and illustrated in connection with certain embodiments, many variations and modifications will be evident to those skilled in the art and may be made without departing from the spirit and scope of the disclosure. The compositions, systems, processes, and methods disclosed herein are thus not to be limited to the precise details of methodology or construction set forth above as such variations and modification are intended to be included within the scope of the disclosure.

### EXAMPLE 4

Previously, SugarDown® (BTI320) is identified through nuclear magnetic resonance spectroscopy (NMR) to be consisted of Galactomannan alpha (GMa) and beta (GMb) in a 1:4 ratio with other constituents including sorbitol. This combination of SugarDown® (BTI320 Chewable Tablets), is identified with an inhibitory activity on carbohydrate-hydrolyzing enzymes and is able to reduce postprandial blood glucose level by reducing available blood glucose for the intestine to absorb.

The purpose of this study is to confirm the interaction between SugarDown® (BTI320 Chewable Tablets), and carbohydrate-hydrolyzing enzymes and to demonstrate the inhibitory activity of SugarDown® (BTI320 Chewable Tablets). Due to a high molecular weight, SugarDown® (BTI320 Chewable Tablets), would first be reduced in size to remove its fibrous nature which may confound the inhibitory activity on carbohydrate-hydrolyzing enzymes. Phase I of this study would be focused in validating that the size reduced SugarDown® (BTI320 Chewable Tablets), has similar structure to the original SugarDown® (BTI320 Chewable Tablets), and can be utilized in further characterization studies without the confounder of fiber.

Methods:

NMR Spectroscopy of Intact SugarDown® Sample

Intact SugarDown® (BTI320) sample was exchanged twice m D20 with intermediate lyophilization, and then dissolved in 0.2 ml of D20 and transferred to a 3 mm OD NMR tube. 1-D Proton and 2-D NMR spectra were acquired on a Varian 600 MHz spectrometer, equipped with 3 mm cold probe (Varian, Inova Palo Alto, Calif.). ID proton spectra were acquired at 40° C. with standard “Presat” solvent signal suppression. All spectra were acquired with standard Varian pulse sequences.

The NMR acquisitions were processed using MNova software (Mestrelab Research, Spain). The spectra were referenced relative to the DSS signal (δH=0 ppm ; δc=0 ppm).

Size-Exclusion Chromatography (SEC) for Estimation of Molecular Weights

SEC was performed on a Superose-12 column (Amersham/GE) in dilute ionic strength conditions (50 mM ammonium acetate, pH 5.5). Analysis was performed using an Agilent LC1200 HPLC system equipped with ELSD detector, at a flow rate of 1 ml/min.

Molecular weight estimations were assigned to eluted peaks by measuring the Kay (average distribution coefficient) for each peak, from the formula:

Kav=(Ve−Vo)/(Vt−Vo)

where Ve=the elution volume of each component peak (measured at peak apex); Vo=void volume (total excluded volume) of the column, measured empirically using a 167,000 MW dextran at 7.89 ml; and Vt=total packed column bed volume (24 ml). Then, using dextran standards of known MW, a plot of Kav vs log MW is obtained, and values of Kay (x) for each unknown peak are entered into the equation y=m(Kav)+b and solved for log MW (y), using linear regression.

For higher MW measurements, PL Aquagel-OH (15 μm, Agilent) column was used.

Dialysis of the Sugarpown® BTI320) Tablets to Remove Low Molecular Weight (LMW) Compounds

SugarDown® tablets (4g ground) were dissolved in 40 ml DI-water and dialyzed in 1OO KDa MWCO membrane (Spectrum labs) against running DI-water for 40 hrs. The removal of LMW was confirmed by SEC analysis. 100 KDa retentate was freeze-dried to give dry fluffy (high molecular weight) HMW residue (SD-d, −160 mg).

Ultrasonication

The dry SD-d (60 mg) was dissolved in 8 ml nano-pure water and the solution was sonicated in ultrasonication instrument (Fisher Scientific) for 2 hours (I-minute pulse with I-minute pulse off). Viscosity of the solution had reduced considerably after the ultrasonication. The resulting solution (SD-u) was analyzed by SEC for molecular weight distribution.

Preparative SEC Separation of SD-u

SD-u (40 mg) was dissolved in water (2 mg/ml) and was applied onto Superose 12 column to separate the reduced MW fraction (F2). 150 μl of the solution was injected into the column every 30 minutes and fractions of lml was collected. Fractions were pooled according to the SEC profile and freeze-dried.

NMR-Spectroscopy F2 and SD-d

Freeze-dried F2 and intact SD-d were analyzed by ID- and 2D-NMR spectroscopy to compare structure of the polymers before and after the ultrasonication.

For deuterium-exchange, both fractions (−5 mg) were dissolved in d20 (1 ml, 99.9% D, Aldrich) and freeze-dried. Freeze-dried samples were dissolved in d20 (0.5 ml, 99.96% D, Cambridge Isotope Lab), 10% acetone (5 μl) was added as internal chemical shift reference standard.

1-D Proton and 2-D gCOSY and HSQC spectra were obtained at 40° C. on Varian Inova

600 MHz spectrometer equipped with cryoprobe using standard Varian pulse sequences. Chemical shifts were measured relative to internal acetone peak (δH/δc=2.22/33 ppm).

1 D/2D NMR Analysis of SugarDown® (Tablets)

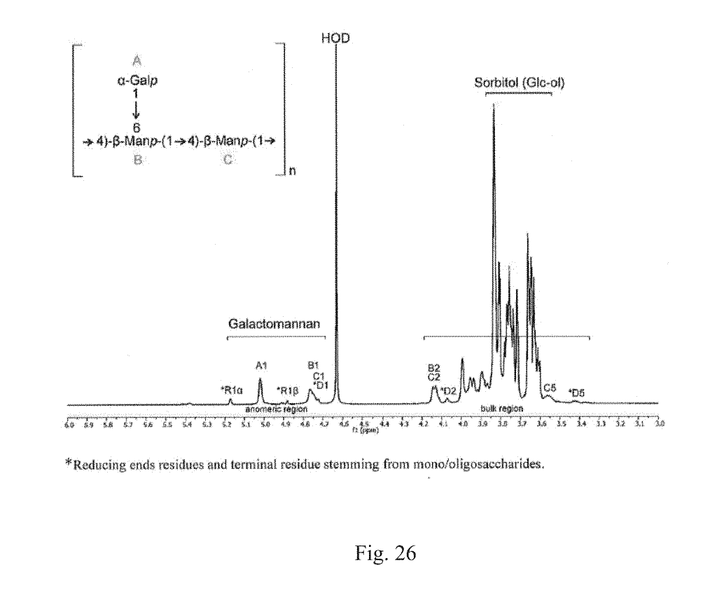

The 1H NMR spectrum of SugarDown® sample revealed that predominant signals observed in the region from o 3.60 to o 3.85, are stemming from sorbitol (residue E, Glc-ol) (FIG. 26, Table 4). The minor signals present in the anomeric region from 4.70 to 5.20 of the spectrum are indicating the presence of galactomannan.

TABLE 4
¹H and ¹³C NMR chemical shifts^{b} of galactomannan and sorbitol present in
SugarDown ® sample recorded in D₂O at 40° C.

| | H-1 | H-2 | H-3 | H-4 | H-5a/5b | H-6a/H-6b |
|---|---|---|---|---|---|---|
| Residue | C-1 | C-2 | C-3 | C-4 | C-5 | C6 |
| A | 5.02 | 3.82 | 3.94 | 4.00 | 3.90 | 3.75/3.90 |
| α-Galp-(1-6)- | 99.0 | 69.6 | 69.7 | 69.6 | 71.5 | 61.0 |
| B | 4.76 | 4.14 | 3.82 | 3.89 | 3.76 | 3.78/3.97 |
| -(1→4,6)-β-Manp-(1→4)- | 100.4 | 70.2 | 71.5 | 77.2 | 73.5 | 66.7 |
| C | 4.75 | 4.14 | 3.80 | 3.89 | 3.56 | 3.75/3.92 |
| -(1→4)-β-Manp-(1→4)- | 100.4 | 7.02 | 71.5 | 77.2 | 75.2 | 61.5 |
| D^{c} | 4.73 | 4.06 | 3.63 | 3.57 | 3.43 | 3.75/3.92 |
| β-Manp-(1→4)- | 100.4 | 70.8 | 73.3 | 67.0 | 76.7 | 61.5 |
| Rα^{a} | 5.18 | 4.00 | n.d. | 3.95 | n.d | 3.72/3.87 |
| -(1→4)-Manp | 94.2 | 71.1 | n.d. | 77.3 | n.d. | 61.2 |
| Rβ^{a} | 4.92 | 4.00 | n.d | 3.82 | n.d | 3.72/3.80 |
| -(1→4)-Manp | 93.9 | 70.9 | n.d. | 77.1 | n.d. | 61.2 |
| Rα^{b} | 5.17 | 3.93 | n.d. | n.d. | n.d. | n.d. |
| -(1→4)-Manp | 94.2 | 71.6 | n.d. | n.d | n.d | n.d |
| Rβ^{b} | 4.90 | 3.94 | n.d. | n.d. | n.d. | n.d. |
| -(1→4)-Manp | 93.9 | 71.6 | n.d | n.d | n.d | n.d |

| | H-1a/H-b | H-2 | H-3 | H-4 | H-5a/5b | H-6a/H-6b |
|---|---|---|---|---|---|---|
| Residue | C-1 | C-2 | C-3 | C-4 | C-5 | C6 |
| E | 3.73/3.61 | 3.83 | 3.83 | 3.65 | 3.77 | 3.82/3.65 |
| Glc-ol | 62.6 | 73.1 | 69.9 | 71.5 | 71.3 | 63.1 |

^{a}Reducing ends residues (Rα/β) and terminal residue (D) are stemming from mono/oligosaccharides (DP1-DP3 according to TLC)
^{b}Free mannose Rα/β)
^{c}not determined

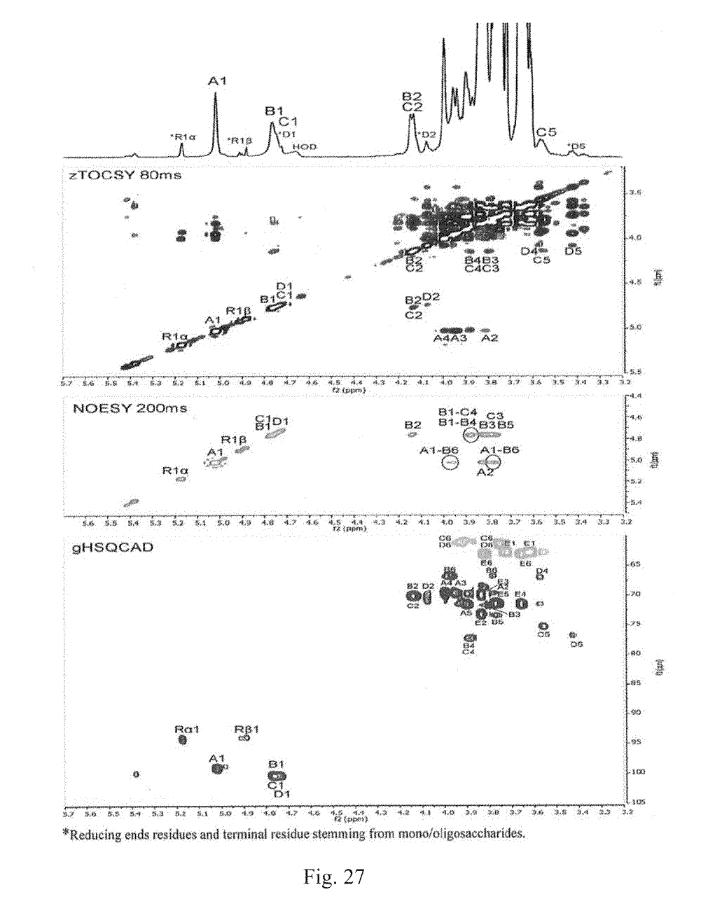

The structure of galactomannan was investigated using 1D and 2D NMR spectroscopy (FIG. 27). The 1 D NMR spectrum showed an anomeric signal of terminal α-galactose (residue A) at δ 5.02 and the signals from β-mannose at δ 4.76 (residue B), δ4.75 (residue C), δ 4.73 (residue D) and o 5.17/4.92 (residues Rα/Rβ, respectively).

2D NMR analysis revealed that the galactomannan polysaccharide possess a backbone of (1-4)-linked P-mannose units which are substituted by single (1-6)-linked a-galactose units. The minor amounts of terminal P-mannose (residue D) and reducing ends (residues Ru/RP) were also detected and suggest a presence of mono/oligosaccharides.

Chemical shifts were assigned by use of gCOSY, zTOCSY 80 ms, NOESY 200 ms, gHSQCAD and gHMBC experiments (Table 1). The residue A was identified as a terminal a-galactose residue by the typical chemical shifts of H-2, 3, 4, including the downfield shift of H-4 resonance at δ 4.00. Less intensive (H-1, H-2) magnetization transfer of the B, C, D, Rα, Rβ residues indicated the presence of P-mannose. The TOCSY spectrum showed on the B, C H-1 s tracks the cross-peak with H-2, whereas the remaining signals H-2,3,4,5 could be found via the H-2. tracks (Table 1, FIG. 27). The HSQC spectrum showed for residue B a downfield shift for B C-4 at δ 77.2 and B C-6 at o 66.7, in accordance with 4,6-substituted β-Manp. Furthermore, 4-substituted β-Manp is present (residue C), as attested by the downfield shift of C-4 resonance at o 77.2. There are also minor anomeric signals present δ 4.73 (D H-1) and δ 5.17 (Ru), o 4.92 (RP) identified as terminal β-Manp, and 4-substituted reducing ends Manp residues, respectively. In the NOESY spectrum (FIG. 27), the strong interresidual connectiviti es (NOEs) B(1-4)B and A(1-6)B suggest a (1-4)-linked β-mannopyranose backbone, substituted at 0-6 with α-galactose units. Furthermore, other observed inter-residual NOEs, B(1-4)C, indicate that some -mannose residues are non-substituted.

Some signals were not assigned due to strong overlap. More structural information will be obtained after purification of galactornannan.

2. SEC Analysis of Intact SugarDown® (BTI320) Tablets, Fenugreek Gum and Sunfiber®

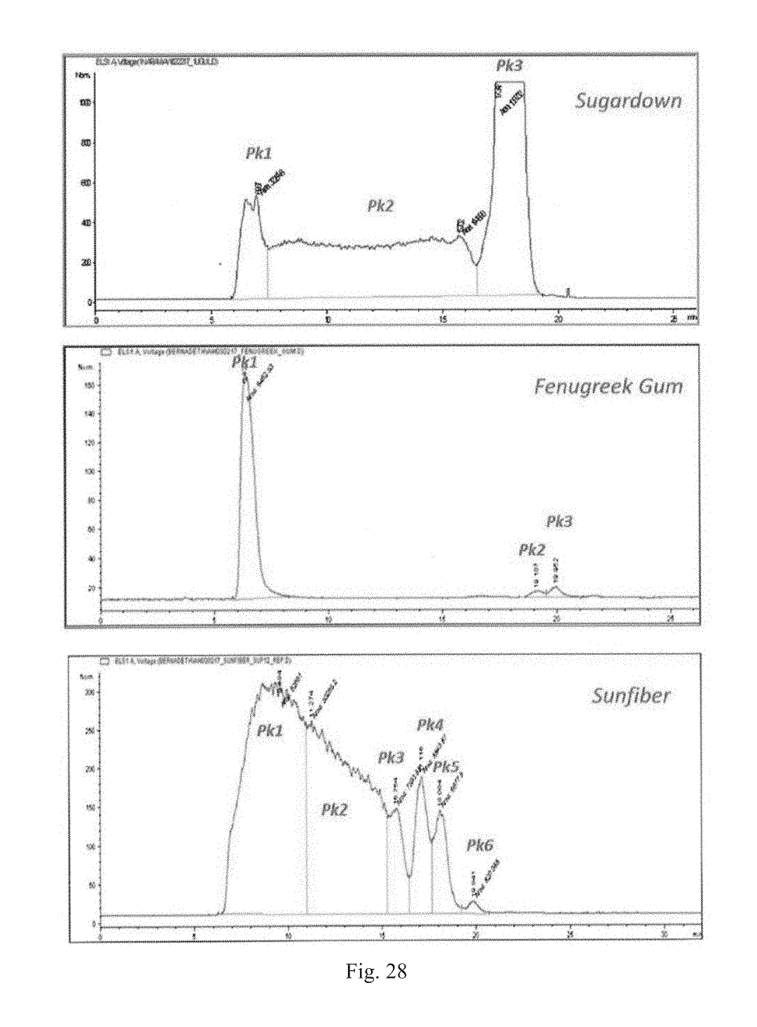

Molecular weight distribution analysis by SEC indicated that the SugarDown tablets are 2% high molecular weight polymers (FIMW) and 98% lower MW (LMW) compounds (FIG. 28 and Table 5). Size of the BMW fraction is in the range higher than 167,000 Da. There's a broad range MW fraction (Pk 2) that is −1,000-100,000 as indicated by the elution pattern.

Fenugreek gum is 93% HMW polymers with MW of >167,000 Da. Very low amount of LMW fraction is detected (FIG. 28 and Table 5).

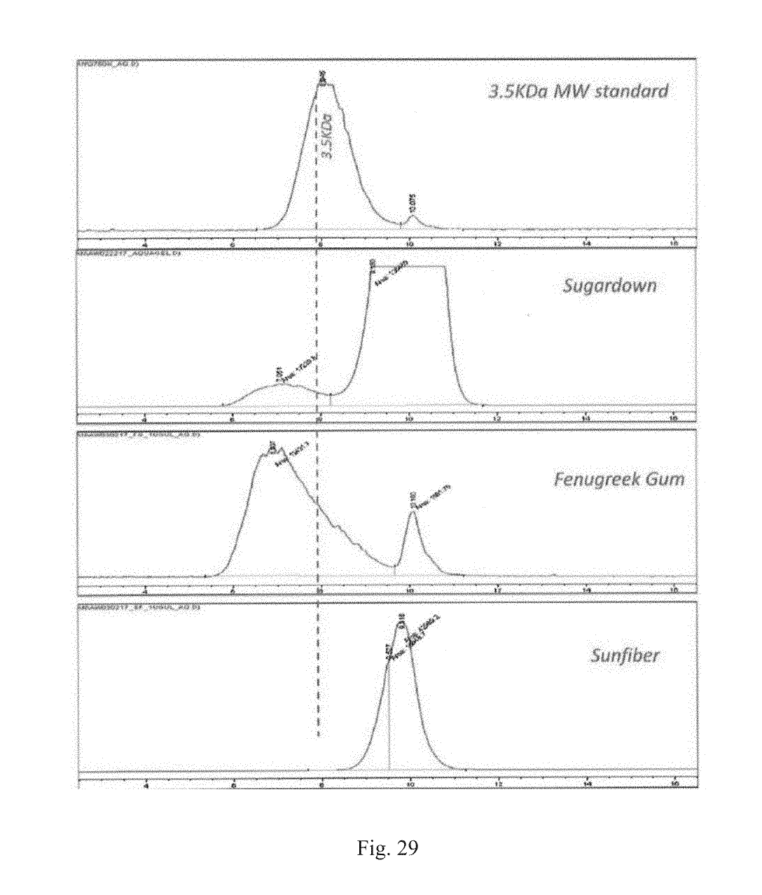

Sunfiber is quite polydisperse in molecular weight. 1-1 MW polymers make up to 45% and MW ranges from 70 KDa through >167,000 Da. There's a broad range MW fraction (Pk 2) that is −1,000-100,000 similar to that of SugarDown sample. Some amount of LMW fractions were detected (FIG. 28 and Tab 5). SEC analysis on Aquagel column (FIG. 29) indicated that the HMW fraction m SugarDown(ii) and Fenugreek gum exceeds MW of the 3,500 KDa standard (FIG. 29).

TABLE 5
MW distribution profile by SEC analysis of intact SugarDown ®
tablets, Fenugreek Gum and Sunfiber ® on Superose 12 column (FIG. 3)

| Peak | MW | Peak area % |
|---|---|---|
| SugarDown ® Sup12 | | |
| Pk 1 | >167,000 | 2.3 |
| Pk 2 | ~1,000-100,000 | 10.5 |
| Pk 3 | ≤180 | 87.1 |
| Total | | 100.0 |
| Fenugreek Gum Sup12 | | |
| Pk 1 | >167,000 | 93.3 |
| Pk 2 | ≤180 | 2.7 |
| Pk 3 | ≤180 | 3.9 |
| Total | | 100.0 |
| Sunfiber ® Sup12 | | |
| Pk 1 | ≥70,000 | 45.8 |
| Pk 2 | ~1,000-100,000 | 36.7 |
| Pk 3 | ~1,000 | 5.5 |
| Pk 4 | <1,000 | 6.5 |
| Pk 5 | ≤180 | 4.9 |
| Pk 6 | ≤180 | 0.6 |
| Total | | 100.0 |

3. SEC Analysis of 100 KDa Retentate of the SugarDown® Before and After Uultrasonication

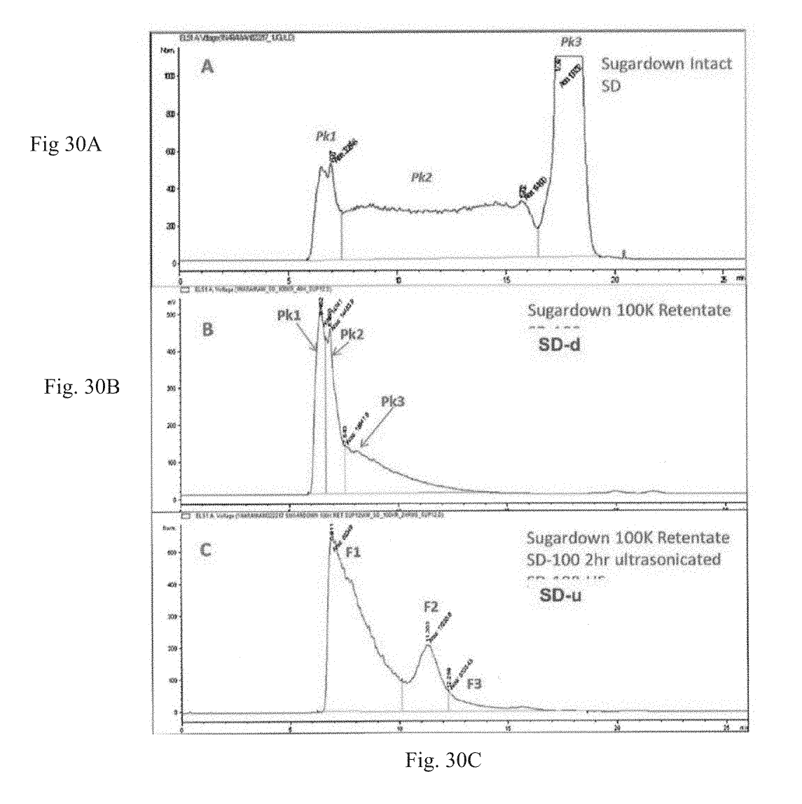

The SEC profiles of intact SugarDown (BTI320) (SD, FIG. 30A) and SugarDown after 100,000 Da MW cut-off dialysis (SD-d, FIG. 30B) indicate that low MW fractions were removed . SD-d free of LMW compounds was further ultrasonicated for 2 hours as described (Methods). The SEC indicated that part of the HMW Pk 1 fraction (FIG. 30, Tab 5) was converted into lower MW fraction (F2 fraction, SD-u FIG. 30C). MW distributions of the SD, SD-d and SD-u are presented in Table 6.

TABLE 6
MW distribution profile by SEC analysis on Superose 12 column

| Sample | Peak | RT, min | Average MW* | Peak area % |
|---|---|---|---|---|
| SD (intact) | Pk 1 | 6.97 | >167,000 | 2.3 |
| | Pk 2 | 9-16 | ~1,000-100,000 | 10.5 |
| | Pk 3 | 17.35 | ≤180 | 87.1 |
| | Total | | | 100.0 |

| Sample | Peak | RT, min | Average MW | Peak area % |
|---|---|---|---|---|
| SD-d (100 KDa retentate) | Pk 1 | 6.462 | >167,000 | 30.8 |
| | Pk 2 | 6.88 | >167,000 | 30.3 |
| | Pk 3 | 7.543 | >67,000 | 38.9 |
| | Total | | | 100.0 |
| SD-u (2 hr. sonicated) | F1 | 6.911 | >167,000 | 73.6 |
| | F2 | 11.3 | ~22,000 | 20.4 |
| | F3 | 12.26 | ~12,000 | 6.0 |
| | Total | | | 100.0 |

*As reported previously, the MW of SD is higher than 3.5 min Da as analyzed by the SEC on Aquagel column (FIG. 4).

Based on the comparative SEC analyses of the intact SD (SD-d) and 2 hour utrasonicated SD-d samples, the average MW of the part of the polymer has been reduced to −22 KDa (Table 6, F2 of SD-u).

Further, preparative SEC to isolate F2, reduced size polymer, and NMR-spectroscopic analysis of SD-d and F2 fraction of SD-u was conducted and NMR-spectra were compared to confirm structure.

Preparative SEC for Isolation of F2 from SD-u Sample

The SD-u sample (-40mg) was fractionated on Superose 12 column to isolate F2 (FIG. 30,C) Collected fractions were pooled and freeze-dried repeatedly to recover F2 fraction for further analysis by NMR-spectroscopy. The practical yield of the F2 fraction was 6.1 mg out of the 40 mg SD-u.

NMR-Spectroscopic Analysis of SD-d and F2 Fraction Iisolated from the SD-u

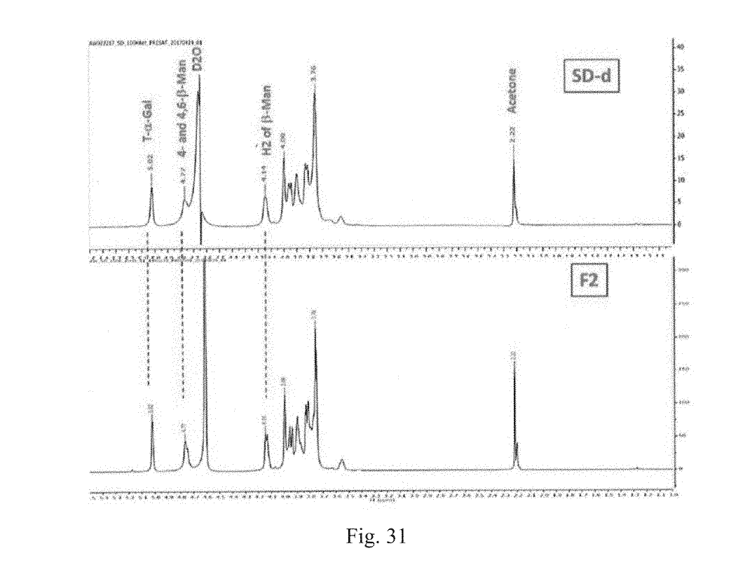

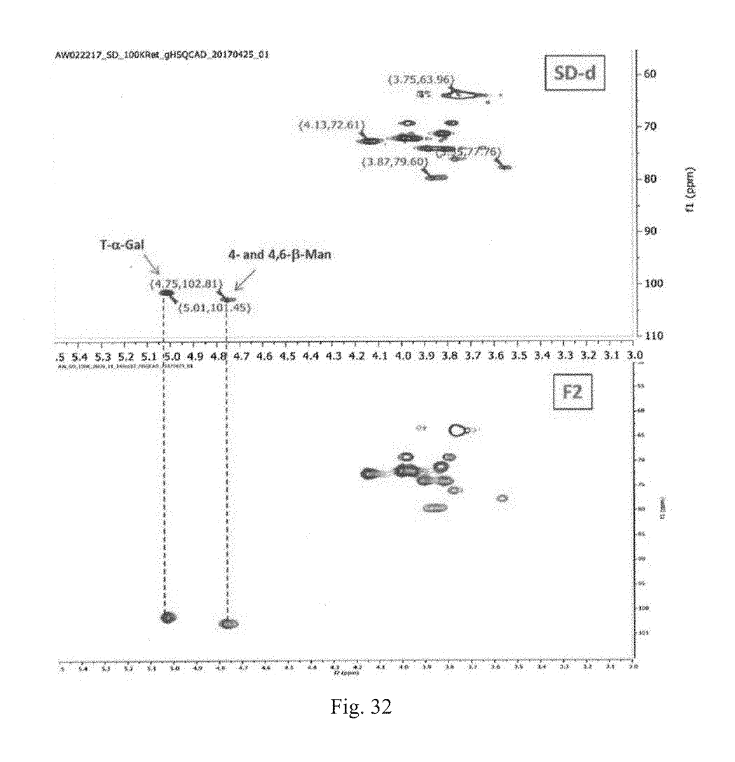

The ID (FIG. 31) and 2D-NMR-spectroscopic analyses (FIG. 32) indicate that the structure of the Galactomannan polysaccharide is conserved after 2 hour ultrasonication. The Proton spectra of the 2 samples—intact 100 KDa retentate of SugarDownCiv (SD-d) and F2 isolated from ultrasonicated SD-d (SD-u) show that the polymer retained original structure after ultrasonication. The ID and 2D NMR. spectroscopic data indicate that F2 has identical structure as the intact SugarDown Gv galactomannan (FIG. 26, 27 and Tab. 1). Anomeric signals of terminal α-Galactosyl (8H/8c ppm 5.02/101.4) and 4- and 4,6-linked 13-Mannosyl (8H/8c ppm 4.75/102.8) residues and ring CH signals detected in the in ID-Proton and 20-HSQC spectra of SD-d and F2 reduced size fraction of SD-u (FIG. 6) match with those of the intact SugarDownCiv (FIG. 26, 27 and Tab. 1).

Results

Overall, the results of SEC and NMR-analyses indicate that the goal of the ultrasonication was accomplished: the MW of the polymer was reduced down to 22,000 Da without alteration of the original structure of the polymer. The polysaccharide in the intact SugarDown®, 100 KDa retentate of SugarDown® and F2 reduced MW polymer of ultrasonicated 100 KDa retentate of SugarDown® have same structure as indicated by NMR-spectroscopic analysis.

### EXAMPLE 5

### Determination of the Postprandial Glucose and Insulin Responses of White Rice Alone and White Rice Consumed with BTI320

Study Design: This study was a Phase 1 study comparing the short-term postprandial blood glucose and insulin responses produced by two test meals containing BTI320, compared to the effects produced by an equal-carbohydrate portion of plain white rice (the control meal). The study used a repeated-measures design, such that every subject consumed each meal on two separate occasions, completing a total of 6 separate test sessions. Each subject completed his/her test sessions on separate mornings at a similar time of day, as close as possible to the time they would normally eat breakfast.

Methods: Ten (10) healthy volunteers (females n=4, males n=6) with a mean age of 29.2 years and a body mass index (BMI) of 27.3 kg/m² participated in the study. Subjects consumed three different test meals comprised of white rice alone or white rice consumed with BTI320 (3 tablets or 6 tablets). Each subject consumed an equal-carbohydrate portion of the three test meals (repeated twice) containing 50 grams of available carbohydrate from the white rice. Each meal was randomized and tested on a separate occasion. Finger-prick blood samples were obtained at −10, 0, 15, 30, 45, 60, 90, and 120 minutes post-meal. Plasma glucose and insulin concentrations were measured and the incremental areas under the 120-minute plasma glucose (iAUC_{Glucose}) and plasma insulin (iAUC_{Insulin}) response curves were calculated.

Results: The mean iAUC_{Glucose} response for the control meal (rice) was significantly greater than the mean glucose responses for the rice+3 tablets of BTI320 (p<0.01) and the rice+6 tablets of BTI320 (p<0.001). The mean iAUC_{Glucose} response for the rice+3 tablets was also found to be significantly higher than the mean iAUC_{Glucose} response for the rice+6 tablets (p<0.05). The mean iAUC_{Insulin} response of the rice meal was significantly greater than the mean insulin responses of the rice+3 tablets meal (p<0.05) and the rice+6 tablets meal (p<0.001). No significant difference was detected between the mean plasma insulin responses of the two test meals containing the BTI320 tablets.

Conclusions: The consumption of BTI320 tablets prior to a high carbohydrate food significantly reduced the 120 minute postprandial glucose (PPG) and insulin responses. The lower dose of BTI320 (3 tablets) resulted in a 19% reduction in PPG and 16% decrease in postprandial insulin response compared to the white rice consumed alone. The higher dose of BTI320 (6 tablets) produced a 32% reduction in the 2-hr glucose response and a 24% reduction in the postprandial insulin response compared to the white rice control meal. There were no serious adverse events.

### EXAMPLE 6

### Safety and Efficacy of the Non-Systemic Chewable Complex Carbohydrate Dietary Supplement BTI320 on Postprandial Glycemia when Added to Oral Agents or Insulin in Subjects with Type 2 Diabetes Mellitus

Study Design: This was a prospective, single-center, open-label, sequential dose-escalation Phase 2 study to assess the safety and efficacy of BTI320 on PPG excursions in individuals with type 2 diabetes who are currently being treated with oral diabetic agents, non-insulin injectable drugs, and/or insulin. A total of 24 subjects were enrolled in the study. Subjects attended four clinic visits: Visit 1 (baseline); Visit 2 (control meal); Visit 3 (control meal with low-dose intervention); and Visit 4 (control meal with high-dose intervention). The low dose treatment comprised 8 g BTI320 (2 tablets); the high dose treatment comprised 16 g BTI320 (4 tablets). Both dosages were administered orally 10 minutes prior to ingestion of the test meal, which consisted of 75 g (dry weight, 60 g carbohydrate) of cooked jasmine rice. The secondary objective of the study was to evaluate the effect of BTI320 on PPG excursions by assessing the glucose area under the curve (iAUC_{Glucose}) over a 3-hour period following ingestion of a reference metabolic food (RMF) and also following usual subject meals at home.

Methods: Each subject took part in the control arm and then started additional treatment with BTI320 at a low dose (8 g) and then high dose (16 g). Efficacy was assessed by measuring changes in PPG parameters (iAUC_{Glucose} and the magnitude of 2 h PPG excursions) were assessed using continuous glucose monitoring (CGM) over the 7-day interventional period. Subjects wore the CGM device throughout the 7-day study period and were blinded to their CGM data. Responders were defined as any subject who showed improvement in iAUC_{Glucose} or magnitude of 2-hour PPG excursions. Safety was assessed through frequency of patient reported adverse events (AEs). CGM data were also analyzed to identify hypoglycemic events.

Results: Twenty-three (23) subjects completed the study and one subject withdrew following the baseline visit. All 23 subjects received at least one dose of BTI320 and were included in the safety evaluation. Among these, 20 subjects were evaluable for analysis of the magnitude of 2-hour PPG excursions (primary endpoint).

Treatment with BTI320 was shown to be efficacious in controlling PPG. Whereas approximately 47% of subjects experienced reductions in postprandial iAUC_{Glucose}, 75% of the subjects experienced meaningful reductions in 2-hour PPG excursions. The responders and non-responders had a significantly different response to the RMF alone; the average and PPG excursion at baseline after eating the RMF was significantly higher for the responders compared to the non-responders.

There were no deaths or serious adverse events in this study. Flatulence was the most common adverse event, reported in 26% of the subjects with low dose and 18% of subjects with high dose BTI320, which was significant compared to baseline (p=0.022). All AEs were resolved following discontinuation of the study medication. No subjects reported allergic reactions to BTI320. There was no association between AEs and efficacy.

Subjects reported no severe hypoglycemic episodes. Three (3) mild hypoglycemic episodes requiring treatment with glucose tablets were reported and recorded. CGM data revealed six (6) severe hypoglycemic events but were not related to BTI320 treatment: two (2) events were attributed to CGM malfunction, two (2) occurred after 12 AM at a time when glucose levels are the lowest, and two (2) occurred on days when no study drug was administered. Seven (7) moderate hypoglycemic events were observed: two (2) of which were probably related to study drug. One (1) mild hypoglycemic event was detected, which was probably related to the study drug.

Conclusions: BTI320 treatment was shown to be beneficial in a substantial number of individuals with type 2 diabetes in reducing 2-hour PPG excursions. Treatment with BTI320 was safe in all patients studied. BTI320 may be useful as an adjunct to decrease postprandial glycaemia in type 2 diabetes, although patients should verify its effect on PPG due to a possible paradoxical response.

### EXAMPLE 7

### Determination of the Glycemic and Insulinemic Values of Soft Drink and Two Test Meals Containing Soft Drink Consumed With BTI320

Study Design: This study was a Phase 1 study comparing the short-term postprandial blood glucose and insulin responses produced by two test meals containing BTI320, compared to the effects produced by an equal-carbohydrate portion of glucose solution (the reference food). The study was a repeated-measures design, such that every subject consumed each meal on two separate occasions, completing a total of 8 separate test sessions. Each subject completed their test sessions on separate mornings at a similar time of day, as close as possible to the time they would normally eat breakfast.

Methods: Ten (10) healthy volunteers (females n=6, males n=4) with a mean age of 32.4 years and a mean BMI value of 27.4 kg/m² participated in the study. Fasting subjects consumed equal-carbohydrate portions of the three test foods (soft drink [Sprite®] alone, soft drink+2 BTI320 tablets, or soft drink+4 BTI320 tablets) and the reference food containing 50 grams of available carbohydrate. Each food was consumed twice by the subjects and each test session was completed on a separate occasion. Finger-prick blood samples were obtained at −10, 0, 15, 30, 45, 60, 90, 120 minutes post-meal. Plasma glucose and insulin concentrations were measured and the incremental areas under the 120-minute plasma glucose (iAUC_{Glucose}) and plasma insulin (iAUC_{Insulin}) response curves were calculated and used to calculate the glycemic and insulinemic index values of the three test foods.

Results: The GI value of the reference food was significantly greater than the mean GI values of all three test foods. The addition of four BTI320 tablets to the soft drink produced a marginally significant reduction in GI (p=0.046). No significant reduction in GI was observed for the soft drink plus two BTI320 tablets compared to soft drink alone (p=0.191). The insulinemic index (II) of the reference food was significantly greater than the mean II values of the 3 soft drink-based test foods. The addition of two or four BTI320 tablets produced a significant reduction in II compared to the soft drink alone (p=0.039 and p=0.014, respectively). Although there was a trend for greater reductions in GI and II with the higher dose of BTI320 compared to the lower dose, these differences were not statistically significant (p=0.594 and p=0.518, respectively).

Conclusion: There were no serious adverse events reported during the study (before, during, or after the test sessions) and none of the subjects withdrew from the study. This study showed that the consumption of BTI320 prior to a sugary beverage (Sprite®) significantly reduced the postprandial glucose and insulin responses to the that beverage. The addition of two BTI320 tablets produced a 10% reduction in GI and a 14% decrease in II of the soft drink. The addition of four BTI320 tablets produced a 14% and 18% reduction in GI and II, respectively, of the soft drink.

### EXAMPLE 8

### A Randomized, Dose-Ranging, Cross-Over, Placebo-Controlled Study of the Effectiveness and Safety of BTI320 vs. Placebo in Type 2 Diabetic Subjects Treatedwith Metformin

Study Design: This was a randomized, double-blind, placebo-controlled, dose-ranging, three-way cross-over Phase 2 study in subjects with type 2 Diabetes (n=18) for at least one year prior to the screening visit. All subjects were on a stable daily dose of metformin for at least three months prior to screening visit. Any concomitant antidiabetic medication other than metformin, including, but not limited to, the following classes of medication: insulin, sulfonylureas, glinides, thiazolidinediones, alpha-glucosidase inhibitors, amylin agonists, DPP-4 inhibitors, and GLP-1 agonists was prohibited. There were a total of five (5) visits: screening (Visit 1), baseline (Visit 2), and 3 treatment visits (Visits 3, 4, and 5).

Methods: At the baseline visit, subjects ingested two placebo tablets and ate a standard rice meal, which consisted of 100 g of dry white rice that was prepared in boiling water. This meal had the following approximate properties: 130 calories and 29 g glycemic carbohydrates in one-half cup after cooking. PPG was measured by blood sampling at time 0 (immediately before meal start), 15, 30, 45, 60, 75, 90, 105, 120, 150, 180, 210, and 240 minutes after meal start. Subjects then took their regular dose of metformin.

Subjects were randomized to BTI320 4 g or 8 g or placebo to one of six treatment sequences. Subjects were instructed to take the tablets within 10 minutes before their morning meal. Subjects resumed their usual activities and were instructed not to make changes to their diet or their regular daily dose of metformin. The study site dispensed a six-day supply of the randomized blinded medication, which the subjects were to take immediately before all daily meals (meal defined as breakfast, lunch, and dinner) until their next treatment visit.

At Visit 3, subjects arrived in a fasting state without taking their usual dose of metformin. The subjects were administered the treatment assigned at the last visit, ate a standard rice meal, and PPG levels were measured over 240 minutes. Subjects resumed their usual activities and were instructed not to make changes to their diet or their regular daily dose of metformin. The study site then provided subjects with a six-day supply of a new treatment arm, which they again took immediately before meals until Visit 4. At Visit 4, the process described above after Visit 3 was repeated through Visit 5. Subject participation was complete after Visit 5.

Results: The least-squared mean (LS-mean) area under the curve of postprandial serum glucose over 4 hours (PPG-AUC-4 hour) for 8 g BTI320 and 4 g BTI320 were 571.8 and 582.9 mg*hr/dL, respectively, while the placebo group had a LS-mean PPG-AUC of 585.9 mg*hr/dL. The mean PPG-AUC-4 hour showed no significant difference of 8 g BTI320 (581.3 mg*hr/dL) or 4 g BTI320 (587.8 mg*hr/dL) compared to placebo (584.4 mg*hr/dL), p=0.663 and 0.926, respectively. The among treatment groups comparison also showed no statistically significant difference (p=0.890).

The LS-mean peak concentrations of postprandial serum glucose (PPG-Cₘₐₓ) for 8 g BTI320 and 4 g BTI320 were 176.5 and 176.1 mg/dL, respectively while the placebo group had a LS-mean PPG-Cₘₐₓ of 169.5 g/dL. The mean PPG-Cₘₐₓ showed similar results for 8 g BTI320 or 4 g BTI320 compared to the placebo group (176.6 and 175.4 mg/dL vs. 170.6 mg/dL). There was no significant difference between 8 g BTI320 and 4 g BTI320 compared to placebo (p=0.470 and 0.498, respectively). Comparison between treatment groups also showed no statistically significant difference (p=0.729).

The median time to peak concentration of postprandial serum glucose (PPG-Tₘₐₓ) was 45.0 minutes for all three treatment groups, the p-values for 8 g BTI320 and 4 g BTI320 vs. placebo were 0.536 and 0.361, respectively. The among treatment groups comparison also showed no statistically significant difference (p=0.650).

The LS-mean peak postprandial serum glucose excursions at 2 hours from baseline (PPGE-2 hour) for 8 g BTI320 and 4 g BTI320 were 12.1 and 4.4 mg/dL, respectively, while the placebo group had a peak PPGE-2 hour of 15.4 mg/dL. The mean PPGE-2 hour for 8 g BTI320 and 4 g BTI320 were 13.8 and 7.0 mg/dL, respectively, while placebo had a PPGE-2 hour of 14.2 mg/dL. There was no significant difference of 8 g BTI320 or 4 g BTI320 compared to placebo (p=0.708 and 0.229, respectively). Comparison among treatment groups also showed no statistically significant difference (p=0.442).

Conclusions: Whereas there were no significant differences between 4 g BTI320, 8 g BTI320, and placebo whether measured by LS-mean or mean PPG-AUC, PPG-Cₘₐₓ, or Tₘₐₓ values over the 4-hour postprandial period, there was a trend to a reduction in the PPG excursion measured over the 2-hour period while administered BTI320 compared with placebo, albeit not dose-dependent. It is important to note that the American Diabetes Association guidelines suggest a 2-hour period for evaluation of pharmacologic effects on postprandial glucose excursion (ADA, 2001). There were no serious AEs reported during the study and AEs were largely gastrointestinal and mild in severity.

### EXAMPLE 9

### A Study to Evaluate the Effect of SUGARDO (BTI320) on Postprandial Hyperglycemia in High Risk Chinese Subjects with Diabetes

Study Design: This was a Phase 2, single-center, randomized, double-blind, placebo-controlled, 3-treatment arm pilot study to evaluate the efficacy and safety of BTI320 in the treatment of high-risk subjects with pre-diabetes (blood glucose levels that were above normal but not reaching diabetic range). Sixty (60) subjects were recruited and randomized into High-Dose BTI320 (HDB) three times daily, Low-Dose BTI320 (LDB) three times daily, or placebo in a 2:2:1 ratio:
HDB 8 g three times daily (n=24)
LDB 4 g three times daily (n=24)
Placebo three times daily (n=12)

A total of 7 visits was scheduled for this 16-week study. Subjects were followed closely for 30 ±7 days after study.

Methods: Randomization was performed after the investigator confirmed that the subject met all inclusion criteria. Study drug was taken prior to each meal ingestion. All subjects were maintained on the same medications throughout the entire study period, as medically feasible, with no introduction of new chronic therapies. All medications were allowed except for medications noted in the exclusion criteria, including anti-diabetic agents and dietary supplements known to affect glucose or galactose metabolism.

### Results:

Efficacy: The primary efficacy analysis showed that the three treatment groups had a minor mean decrease in fructosamine level after 4 weeks of treatment (not statistically significant). Similar results of a minor mean decrease in serum fructosamine level from baseline were also observed in the secondary efficacy comparison of the LDB and HDB treatment groups to the placebo group after 8, 12, and 16 weeks of treatment. No hypoglycemic effects were observed.

The LDB treatment group showed a statistically significant decrease in mean weight at Visit 7 (p=0.03), which also approached significance at the follow-up visit (p=0.05) compared to placebo with estimate treatment effects of −1.7 and −2.1 kg, respectively. Minor decreases in mean weights and waist circumference across three treatment groups were observed throughout all study visits.

In a linear mixed model analysis adjusting for repeated measures within visits, the LDB treatment group demonstrated statistically significant differences in lowering mean PPG levels and post-meal glucose over meals within visits compared to placebo at 1, 2, and 3-hour post meal and overall post-meal glucose values with p-values ranging from <0.01 to 0.02.

The mean Hb_{A1c} levels were similar among the three treatment groups at Visit 1 (−7 to −14 days) and Visit 7 (Week 16). All values remained within the defined Hb_{A1c} range of 5.7-6.4%. The LDB and HDB treatment groups were not statistically significant different in mean changes of Hb_{A1c} levels from baseline at Week 16 compared to the placebo group.

The standard meal tolerance test (MTT) results of subjects treated with HDB and LDB showed a greater decrease in iAUC_{G}lucose and C-Peptide from baseline compared to placebo at Week 16. None of the differences were statistically significant, except for the LDB treatment group at Week 4 which showed a significant mean increase in iAUC 120 min C-Peptide from baseline compared with the placebo group (p=0.04). Dose dependent results were observed at Week 16 (Visit 7) in iAUC_{Glucose} and C-Peptide levels.

The majority of systolic and diastolic BP values measured were within the normal reference range. Overall, the highest mean SBP was <130 mmHg and the highest mean DBP was <82 mmHg; the mean changes in SBP and DBP were minor throughout all visits.

The HDB treatment group demonstrated a consistent positive effect in reduction of total cholesterol, LDL cholesterol, and triglycerides and an increase in HDL cholesterol. At Week 16, the HDB treatment group showed a statistically significant decrease (p=0.02) in mean triglyceride values and a significant increase in HDL cholesterol levels (p=0.05) compared to placebo.

Safety: Of the 60 treated subjects, 41 (LDB, 18/24; HDB, 16/24; Placebo, 7/12) experienced 104 all-causality AEs (LDB, 47; HDB, 36; Placebo, 21). The most commonly experienced AEs: flatulence (LDB, 29.2%; HDB, 29.2%; Placebo, 16.7%), abdominal distension (LDB, 25.0%; HDB, 16.7%; Placebo, 8.3%), and diarrhea (LDB, 16.7%; HDB, 12.5%; Placebo, 8.3%), were possibly related to study drug. All of the AEs were mild or moderate in severity except for two events, osteosarcoma and flatulence, which were rated as severe. The former, osteosarcoma, was reported as a serious adverse event (SAE); the subject discontinued from the study due to this unrelated SAE. Additionally, one subject who received LDB experienced moderate abdominal pain and diarrhea which were considered possibly related to treatment by the investigator and discontinued from the study. The gastrointestinal AEs resolved in 6 days.

The majority of laboratory safety test results for complete blood count (hemoglobin, hematocrit, platelet, WBC), liver function tests (bilirubin, ALP, and ALT), and renal function (serum sodium, potassium, urea, creatinine) were within normal ranges. None of the abnormal values were clinically significant nor reported as an AE.

Questionnaire survey results for QOL: Appetite, International Physical Activity, and Dietary, showed no remarkable differences except the HDB treatment group had a statistically significant mean increase from baseline in “Days doing vigorous physical activities” compared to placebo (p=0.03) at Visit 4; and the placebo group had a significant mean increase in the Social Relationship Domain total score from baseline at Visit 4, compared to the LDB and HDB treatment groups (p<0.01 and p=0.03, respectively).

Conclusion: The changes in baseline fructosamine levels from baseline to 4 weeks were −5.2, −9.4, and −8.8 μmol/L in subjects receiving low dose BTI320, high dose BTI320, and placebo, respectively. The estimated mean differences in change in fructosamine levels were not significant for comparison between intervention with BTI320 and placebo. Management of post-prandial sugar spikes is critical for the prevention of diabetes, and treatment with 4 g BTI320 significantly reduced post-prandial glucose AUC in 1 hour (p<0.01), 2 hours (p=0.01) and 3 hours (p=0.02) post meal and post-meal maximum glucose (p=0.01), secondary endpoints of the study. Additionally, 8 g BTI320 reduced serum triglyceride and increased HDL cholesterol.

Overall, BTI320 was relatively well tolerated and no hypoglycemic symptoms or events were reported in the study. The most common side-effects possibly associated with BTI320 were abdominal distension, flatulence, and diarrhea occurring in approximately 20-30% of treated subjects. Most of these were mild to moderate in severity. No deaths occurred in the study.

A study of treatment of processed guar gum (gel-forming galactomannan polysaccharide) in 6 healthy subjects and 17 diabetics (6 insulin-dependent and 11 diet and tablet treated) observed a significant decrease (P<0.05) in PPG response and fasting blood glucose in the diabetics. These diabetic subjects also observed a significant decrease (P<0.05) in insulin levels. There was no significant observation reported for the healthy patients in either PPG or insulin. The study also observed a decrease in cholesterol levels for both the healthy and diabetic subjects; however, α-lipoprotein cholesterol, plasma triglycerides, and body weight remained unchanged. The reduction in cholesterols was significantly correlated with the initial level; average α-lipoprotein cholesterol/cholesterol increase of 18% for all subjects, where as 26% was observed in 4 patients whose initial cholesterol was over 7 mM. The guar gum was well tolerated by most patients, with the most frequent reported AEs of flatulence and abdominal cramps. Two insulin-dependent patients reported frequent hypoglycemic episodes and reduced their insulin doses 4-8 IU/day. The treatment had no influence in blood chemistry analyses (K⁺, Ca⁺², alkaline phosphatase (ALP)/liver function) (Smith and Holm, 1982).

What is claimed is:

1. A composition comprising:
at least one first purified soluble mannan polysaccharide of high molecular weight;
at least one second purified mannan polysaccharide of low molecular weight; and
at least one oligosaccharide and/or monosaccharide.

2. The composition according to claim 1, wherein the at least one first purified soluble mannan polysaccharide of high molecular is about 50 kD to about 300 kD.

3. The composition according to claim 1, wherein the at least one second purified mannan polysaccharide of low molecular weight is about 5 kD to about 50 kD.

4. The composition according to claim 1, wherein the ratio of low molecular weight mannan polysaccharide to high molecular weight mannan polysaccharide is about 2:1 to about 100:1 by weight.

5. The composition according to claim 1, wherein at least one of the at least one first purified soluble mannan polysaccharide of high molecular weight and the at least one second purified mannan polysaccharide of low molecular weight is fractionated from one or more legume seeds, the one or more legume seeds including at least one of Cassia fistula, Ceratonia siliqua, Cæsalpinia spinosa Trigonelle foenum-graecum, and/or Cyamopsis tetragonolobus.

6. The composition according to claim 1, wherein the at least one first purified soluble mannan polysaccharide of high molecular weight and the at least one second purified mannan polysaccharide of low molecular weight are purified to at least about 90% polymeric carbohydrates.

7. The composition according to claim 1, wherein the at least one first purified soluble mannan polysaccharide of high molecular weight and the at least one second purified mannan polysaccharide of low molecular weight are purified to contained less than about 1% of natural non-polysaccharides impurities including proteins, alkaloids, glycoalkaloids and provide hypoallergenic dietary fibers.

8. The composition according to claim 1, wherein the at least one first purified soluble mannan polysaccharide of high molecular weight and the at least one second purified mannan polysaccharide of low molecular weight are purified to remove at least a portion of environmental and agricultural contaminants including heavy metals, pesticides, herbicides, microbial toxins and mycotoxins.

9. The composition according to claim 1, wherein the at least one first purified soluble mannan polysaccharide of high molecular weight is embedded in the at least one second purified mannan polysaccharide of low molecular weight forming at least one combined mannan polysaccharide; and wherein the at least one combined mannan polysaccharide is embedded in the at least one oligosaccharide and/or monosaccharide.

10. The composition according to claim 9, wherein the composition is in the form of at least one of a chewable tablet, a caplet, a gel-cap, a succulent, and a concentrated liquid-gel.

11. The composition according to claim 10, wherein the composition dissolves within about 1 minute to about 30 minutes upon contact with water, saliva, or other fluid.

12. The composition according to claim 10, wherein the composition contains:
about 1% to about 25% (wt/wt) of the at least one first purified soluble mannan polysaccharide of high molecular weight,
about 20% to about 80% (wt/wt) of the at least one second purified mannan polysaccharide of low molecular weight, and
about 40% to about 60% (wt/wt) of the at least one oligosaccharide and/or monosaccharide.

13. A composition comprising:
a purified soluble mannan polysaccharide; and
at least one of an oligosaccharide, a monosaccharide, and a sugar alcohol.

14. The composition according to claim 13, wherein the purified soluble mannan polysaccharide is about 50 kD to about 300 kD.

15. The composition according to claim 13, wherein the purified soluble mannan polysaccharide is about 5 kD to about 50 kD.

16. The composition according to claim 13, wherein the purified soluble mannan polysaccharide includes a first purified soluble mannan polysaccharide of a high molecular weight and a second purified soluble mannan polysaccharide of a low molecular weight.

17. The composition according to claim 16, wherein the composition includes:
about 1 gram of the first purified soluble mannan polysaccharide of a high molecular weight
about 2.0 grams of the second purified soluble mannan polysaccharide of a low molecular weight; and
about 1 gram of the sugar alcohol.

18. A method of producing a purified soluble mannan polysaccharide comprising:
blending powdered legumes seeds to a semi-liquid mixture to solubilize and extract proteins and pigments from the semi-liquid mixture;
diluting the semi-liquid mixture in acid to remove acid soluble contaminants;
heating the diluted semi-liquid mixture to fractionate at least one mannan polysaccharide;
mixing the diluted semi-liquid mixture with a solvent after heating the diluted semi-liquid mixture to remove lipopolysaccharides; and
collecting a mannan polysaccharide precipitate from the diluted semi-liquid mixture.

19. The method of claims 18, further comprising drying the mannan polysaccharide precipitate to obtain a powder.

20. The method of claims 19, further comprising milling the powder.
